(19) United States
(12) Patent Application Publication
(10) Pub. No.: US 2022/0139252 A1
(43) Pub. Date: May 5, 2022

(54) SYSTEM AND METHOD OF TRAINING A STUDENT WITH A SIMULATOR

(71) Applicant: FlightSafety International Inc., Melville, NY (US)

(72) Inventors: Bert L. Sawyer, Broken Arrow, OK (US); Matthew D. Littrell, Wichita, KS (US)

(73) Assignee: FlightSafety International Inc., Melville, NY (US)

(21) Appl. No.: 17/506,239

(22) Filed: Oct. 20, 2021

Related U.S. Application Data
(60) Provisional application No. 63/108,063, filed on Oct. 30, 2020.

(51) Int. Cl. G09B 19/00; G09B 9/16; G09B 9/12

(52) U.S. Cl. CPC G09B 19/003; G06N 20/00; G09B 9/12; G09B 9/165

(57) ABSTRACT

The present disclosure provides systems and methods of evaluating performance of a student during a training session in a training device. The systems and methods include receiving data, comparing performance of the student to a model, and assigning a score to the student. In one embodiment, the training device is a flight simulator configured to teach the student to operate an aircraft. The flight simulator displays output to the student and receives input from the student.

### CROSS-REFERENCE TO RELATED APPLICATIONS

This application claims priority under 35 U.S.C. § 119(e) to U.S. Provisional Patent Application Ser. No. 63/108,063 filed Oct. 30, 2020, and entitled “System and Method of Training a Student with a Simulator,” which is incorporated herein in its entirety by reference.

### FIELD

The present disclosure relates to training students to operate equipment or a vehicle with a training device, such as a simulator. More specifically, the present disclosure provides systems and methods of training students to operate or maintain an aircraft or other vehicles using a training device.

### BACKGROUND

Training a student to operate or maintain a vehicle, such as an aircraft, is expensive and time consuming. The student must learn how to perform many tasks required to safely operate or maintain the vehicle. Some tasks are difficult and can be dangerous when executed in or on the vehicle. In addition, aircraft and other vehicles are very expensive to operate and student time in the vehicle may be limited during training.

Training devices, including flight simulators, improve the efficiency of training the student to operate a vehicle. Modern training devices can replicate the operating characteristics of virtually any type of vehicle, including aircraft (such as commercial aircraft, military aircraft, smaller private aircraft, rotor-craft or even remotely piloted vehicles) and other types of vehicles, such as trains, ships, wheeled or tracked vehicles, and spacecraft. Training devices enable the student to practice operating the vehicle in a safe environment.

Training devices may include controls, instruments and displays that simulate those of the vehicle the student is learning to operate. Depending on the vehicle type, the training device can have positions or roles for one or more students. The student executes tasks that are required to operate the vehicle during a training session using the training device. A computer that controls the training device receives inputs to the controls from the student and then changes the output of the instruments and displays to emulate the performance of the vehicle.

An instructor observes the student during the training session and evaluates the performance of the tasks executed by the student in the training device. It is difficult for the instructor to observe and evaluate the student for several reasons. First, depending upon the type of vehicle, the training session may be quite long. For some vehicles, a typical training session may have a duration of four or more hours. The long length of a training session means the instructor must be alert for long periods of time while keeping accurate notes on the student's actions and performance.

Other challenges faced by the instructor when trying to observe the student are obstructed or limited views of the student. The instructor may be positioned within an enclosure of the training device with the student. However, in some training devices, the instructor is positioned behind the student and the instructor's view may be obstructed by equipment, a seat or the student's body.

For some other training devices, the instructor is separated from the student and observes the student remotely. For example, training devices for some aircraft, such as high performance fighters (or other single seat vehicles) do not have space within the enclosure for the instructor to be seated near the student. The instructor must watch the student's input to the controls and record observations while receiving data from the training device. Accordingly, it is not always possible for the instructor to observe or record all of the student's actions and inputs to the controls due to the position of the student during the training session.

Another problem with known training devices is that the instructor may not observe an inadvertent or unintended input by the student to a control. In addition, the instructor cannot quantify an amount of force the student applies to a control while executing a task. The instructor also cannot perceive or record the student's movements or the movement of the student's eyes between the displays and instruments of the training device. As a consequence, the instructor may miss or not remember actions (or inaction) and inadvertent inputs to controls by the student that occur during execution of a task performed during the training session. The instructor also may not be able to cognitively assemble data from student's actions that occur during the training session.

It is even more challenging for an instructor to evaluate the performance of students during training sessions that have more than one student. The instructor may not see an input from a first student that affects the performance and evaluation of a task executed by a second student. The first student may make an input to a control that corrects (or causes) an error of the second student. Accordingly, when the instructor does not observe the input of the first student, the instructor may incorrectly rate the performance of the second student. Although the training session may be recorded, it is rarely possible to identify potential performance issues in the recording. Further, it is time consuming for the instructor to review the recording to complete evaluation of the student.

Instructors also do not evaluate students in a consistent manner. More specifically, two different instructors may score a task performed by a student differently. This may be because the two instructors focus on different actions taken by the student during performance of the task. The instructors may also have different levels of experience operating the vehicle or instructing students.

Accordingly, there is need for systems and methods of objectively evaluating performance of a student during a training session with a training device.

### SUMMARY

One aspect of the present disclosure is a system and a method of objectively evaluating performance of tasks executed by a student during a training session with a training device.

It is another aspect to provide a system and a method of organizing tasks for execution by a student during a training session. In one embodiment, one or more features may be identified for each task. Optionally, one or more of the features must be successfully completed for the student to “master” or successfully complete the task.

Still another aspect of the present disclosure is a system and a method of predicting completion of a task and probability of successful completion of the task by a student.

One aspect of the present disclosure is a system and method of determining a task for a student to perform to successfully complete a training course.

In one embodiment, the system and method determine an amount of time it will take for the student to successfully complete the course.

Another embodiment includes recommending additional or remedial training on tasks to improve the probability that the student will successfully complete the course.

Additionally, or alternatively, the system and method can recommend a change in lessons for the student based on the performance of the student.

One aspect is a system and method of identifying a root cause of a deviation from acceptable performance of a task by a student.

In one embodiment, the system and method can identify an error chain that led or contributed to the deviation from acceptable performance. For example, the system and method may identify an action or inaction by the student that resulted in deviation from a standard for a task. Additionally, or alternatively, the system and method can identify an action (including inaction) at a first time during the student's execution of the task that led to the deviation at a second time during the student's execution of the task, the first time being before the second time.

Yet another aspect of the present disclosure is a system and method of evaluating the performance of a student using machine learning. This may include evaluating the student's execution of a task during a training session with a training device, such as a flight simulator.

One aspect of the present disclosure is a training system for training a student to operate a vehicle and to evaluate performance of the student during a training session using a training device, comprising: (1) a display system; (2) an input apparatus to receive an input from the student during execution of a first task during the training session; (3) a sensor to record data during the training session; and (4) a control system including a processor, a non-transitory computer-readable storage medium, and instructions stored on the non-transitory computer-readable storage medium for execution by the processor, the instructions including: (a) an instruction to receive data from the sensor; (b) an instruction to compare performance of the first task by the student to a model of the first task; (c) an instruction to assign a first score to the performance of the first task by the student; (d) an instruction to identify a reason for a deviation from a baseline for the first task performed by the student; (e) an instruction to determine a recommended action for the student to improve performance of the first task; and (f) an instruction to select a second task for the student to execute during the training session.

The input apparatus includes controls that are the same as, or similar to, the controls of the vehicle the student is learning to operate. In one embodiment, the input apparatus includes a throttle and a steering element. Additionally, or alternatively, the input apparatus includes one or more of a pointer, a mouse, a keyboard, a touch screen, a button, a switch, a knob, a lever, and a wheel.

In one embodiment, the control system automatically initiates the second task during the training session.

Optionally, the instructions further comprise one or more of: an instruction to identify the first task performed or being performed by the student based on the data received from the sensor; an instruction to send a signal to the display system to provide a virtual view associated with the second task; an instruction to compare performance of the second task by the student to a model of the second task; and an instruction to assign a second score to the performance of the second task by the student.

In one embodiment, the instruction to select the second task includes an instruction to retrieve a persona associated with the student from a database. The persona associated with the student indicates a vehicle operating style associated with the student. More specifically, the persona means a particular style of operating a vehicle (such as, flying an aircraft) exhibited by the student. In one embodiment, the persona associated with the student is created by the control system by evaluating data collected by the sensor during a training session of the student.

The persona is used by the control system or an instructor to adapt instructional technique to the student. Additionally, the persona is utilized as a baseline adaptation to the training curriculum to optimize the learning path of the student.

Optionally, the instruction to select the second task includes an instruction to review sensor data collected as the student performed the first task during a previous training session in the training system. In one embodiment, the second task may be selected based at least in part on data collected when the student performed a different task.

In one embodiment, the instructions further comprise an instruction to determine a probability that the student will successfully complete a training course associated with the first task.

The control system may include an instruction to generate a user interface. The user interface may be displayed on a display screen associated with a computing device such as a laptop computer, a desktop computer, or a tablet computer. In one embodiment, the user interface includes the first score. The user interface may optionally include the recommended action. Additionally, or alternatively, the user interface includes the probability that the student will successfully complete the training course. Optionally, the user interface includes a list of tasks the student should practice. The user interface may also include a list of tasks the student does not need to practice.

The control system may create the model of the task based on data collected when a vehicle operator performs the task in the training device. Optionally, the control system creates the model using a machine learning method. The control system may use one or more of a supervised machine learning method, an unsupervised machine learning method, and a semi-supervised machine learning method to create the model.

The training system may further comprise a motion element to move a portion of the training device to replicate motion of the vehicle. In one embodiment, the motion element can move an enclosure or a cabin of the training device. Additionally, or alternatively, the motion element can move a station or a seat for the student. In one embodiment, the motion element can move a portion of the training device in one or more of a pitch orientation, a roll orientation, and a yaw orientation

In one embodiment, the training system is a simulator for a vehicle. The vehicle may be an aircraft, a wheeled vehicle, a tracked vehicle, a train, a ship, or a spacecraft. In one embodiment, the training system is an aircraft flight simulator.

Another aspect of the present disclosure is a computer-implemented method of evaluating performance of a task in a training device by an operator. The method includes: (1) receiving data collected when the operator performs the task; (2) comparing performance of the task by the operator to a model of the task; (3) assigning a score to the performance of the task by the operator; (4) identifying a reason for a deviation from a standard or baseline for the task; (5) providing a recommended action for the operator to improve performance of the task; and (6) generating a user interface that includes the recommended action and the score.

In one embodiment, the method further includes generating the model of the task by: receiving data of operators performing the task in the training device; and creating the model of the task using the received data. In one embodiment, the operators are proficient at operating the vehicle. The model may be based on a published standard associated with the task.

Optionally, creating the model includes using a machine learning method. In one embodiment, the machine learning method is one or more of a supervised machine learning method, an unsupervised machine learning method, and a semi-supervised machine learning method.

The method may further comprise identifying criteria to determine initiation of the task and completion of the task.

In one embodiment, the data comprises a plurality of tasks performed by the operator using the training device. The data is collected by a sensor associated with the training device.

The method optionally further includes determining a start time and an end time of the task using the initiation criteria and the completion criteria.

In one embodiment, the method further comprises determining a probability that the operator will successfully complete a training course associated with the task.

The training device may be a simulator for a vehicle, such as an aircraft, a wheeled vehicle, a tracked vehicle, a train, a ship, or a spacecraft. Optionally, the training device is an aircraft flight simulator and the task is an aircraft operation or a maintenance action. In one embodiment, the operator is a student learning to operate an aircraft. In another embodiment, the operator is learning to maintain the vehicle.

One aspect of the present disclosure is to provide a training system for evaluating performance of a task in a training device by a student and providing feedback to the student, comprising: (1) a processor; (2) a non-transitory computer-readable storage medium; and (3) instructions stored on the non-transitory computer-readable storage medium for execution by the processor. In one embodiment, the instructions include one or more of: (a) an instruction to receive data collected when the student performs the task; (b) an instruction to compare performance of the task by the student to a model of the task; (c) an instruction to assign a score to the performance of the task by the student; (d) an instruction to identify a reason for a deviation from a baseline for the task; (e) an instruction to provide a recommended action for the student to improve performance of the task; and (f) an instruction to generate a user interface that includes the recommended action and the score.

In one embodiment, the data is collected by a sensor associated with the training device. The instructions may optionally include one or more of: (i) an instruction to receive data of an operator proficient in the vehicle performing the task in the training device; and (ii) an instruction to create the model of the task using the received data.

In one embodiment, creating the model includes using a machine learning method. Optionally, the machine learning method is one or more of a supervised machine learning method, an unsupervised machine learning method, and a semi-supervised machine learning method. Additionally, or alternatively, the model is based on a published standard associated with the task.

In one embodiment, the training system is connected to the training device.

Optionally, the task is a flight maneuver or other aircraft operation. In one embodiment, the student is a crew member learning to operate or maintain the aircraft. Accordingly, in this embodiment, the training device is a simulator for an aircraft. The task may optionally be a maintenance action.

In another embodiment the training device is configured to simulate operation of a land vehicle (such as a car, a truck, a tracked vehicle, or a train), a water vehicle (a ship or a submersible), or a spacecraft.

Yet another aspect of the present disclosure is a computer-implemented method of organizing data collected by a training device to create a hierarchy of learning parameters to evaluate performance of students. The computer-implemented method comprises: (1) receiving data of operators performing tasks using the training device, the tasks associated with operation of a vehicle; (2) using a machine learning method to evaluate the received data to create a model of a task; (3) identifying criteria associated with initiation of the task; (4) identifying criteria associated with completion of the task; and (5) identifying a feature of the task that occurred between initiation and completion of the task.

In one embodiment, the machine learning method is one or more of a supervised machine learning method, an unsupervised machine learning method, and a semi-supervised machine learning method.

The method optionally further comprises at least one of assigning a scoring weight to the task and assigning a scoring weight to the feature.

In one embodiment, the method includes retrieving a published standard associated with the task.

Still another aspect of the present disclosure is a system for organizing data collected by a training device to create a hierarchy of learning parameters to evaluate performance of students, comprising: (1) a processor; (2) a non-transitory computer-readable storage medium; and (3) instructions stored on the non-transitory computer-readable storage medium for execution by the processor, including: (a) an instruction to receive data of a proficient operator performing tasks with the training device, the tasks associated with operation of a vehicle; (b) an instruction to use a machine learning method to create a model of a task from the received data; (c) an instruction to identify criteria associated with initiation of the task; (d) an instruction to identify criteria associated with completion of the task; and (e) an instruction to identify a feature of the task that occurred between initiation and completion of the task.

In one embodiment, the vehicle is an aircraft, a wheeled vehicle (such as a car, a truck, or a train), a tracked vehicle, a water vehicle (for example, a ship or a submersible), or a spacecraft. The training device may be a simulator. Optionally, the simulator is a flight simulator and the vehicle is an aircraft. In one embodiment, the task is associated with operation of the vehicle. Additionally, or alternatively, the task is related to maintenance of the vehicle.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more clear from the Detailed Description, particularly when taken together with the drawings.

As used herein the term vehicle means any type of mobile equipment including without limitation wheeled vehicles (including cars, trucks, and trains), tracked vehicles (such as tanks or construction vehicles), water vehicles and ships (including surface vessels and submersible vessels), aircraft (including both fixed wing aircraft, helicopters, and remotely piloted vehicles), and spacecraft. The vehicle may be a crewed vehicle or remotely operated.

The terms “training equipment” and “training device” refer to means configured to emulate any type of vehicle. In one embodiment the training device includes a display and an input device. The training device may be a vehicle simulator. In some embodiments, the vehicle simulator is a flight simulator. In one embodiment, the vehicle is an aircraft. In other embodiments, the vehicle simulator emulates a ground vehicle (such as a car, a truck, a train, or a tracked vehicle), a ship, or a spacecraft. The vehicle simulator may include stations for one, two, or more students or operators. Optionally, the vehicle simulator includes actuators to move a crew station (or cabin) to emulate movement of the vehicle. In one embodiment, the simulator is a desktop computer with a display and input devices for the operator, the desktop computer running a simulation program. In another embodiment, the simulator includes a panoramic display with a radius of curvature that extends at least 120° around a crew station to provide an immersive virtual reality experience to the operator.

As used herein, the phrase “operate a vehicle” includes actions taken to control a vehicle. For example, operating a vehicle includes actions taken by a student flying an aircraft or operating an aircraft on the ground. Accordingly, the training system of the present disclosure may be used to train a student to operate a vehicle or other machinery. However, it will be appreciated by one of skill in the art that training systems and training devices of the present disclosure may also be used to training a student to perform maintenance or service components of a vehicle.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

Unless otherwise indicated, all numbers expressing quantities, dimensions, conditions, ratios, ranges, and so forth used in the specification and claims are to be understood as being modified in all instances by the term “about” or “approximately”. Accordingly, unless otherwise indicated, all numbers expressing quantities, dimensions, conditions, ratios, ranges, and so forth used in the specification and claims may be increased or decreased by approximately 5% to achieve satisfactory results. Additionally, where the meaning of the terms “about” or “approximately” as used herein would not otherwise be apparent to one of ordinary skill in the art, the terms “about” and “approximately” should be interpreted as meaning within plus or minus 5% of the stated value.

All ranges described herein may be reduced to any sub-range or portion of the range, or to any value within the range without deviating from the invention. For example, the range “5 to 55” includes, but is not limited to, the sub-ranges “5 to 20” as well as “17 to 54.”

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

The term “automatic” and variations thereof, as used herein, refer to any process or operation done without material human input when the process or operation is performed. However, a process or operation can be automatic, even though performance of the process or operation uses material or immaterial human input, if the input is received before the performance of the process or operation. Human input is deemed to be material if such input influences how the process or operation will be performed. Human input that consents to the performance of the process or operation is not deemed to be “material.”

The term “bus” and variations thereof, as used herein, can refer to a subsystem that transfers information and/or data between various components. A bus generally refers to the collection communication hardware interface, interconnects, bus architecture, standard, and/or protocol defining the communication scheme for a communication system and/or communication network. A bus may also refer to a part of a communication hardware that interfaces the communication hardware with the interconnects that connect to other components of the corresponding communication network. The bus may be for a wired network, such as a physical bus, or wireless network, such as part of an antenna or hardware that couples the communication hardware with the antenna. A bus architecture supports a defined format in which information and/or data is arranged when sent and received through a communication network. A protocol may define the format and rules of communication of a bus architecture.

The term “communication system” or “communication network” and variations thereof, as used herein, can refer to a collection of communication components capable of one or more of transmission, relay, interconnect, control, or otherwise manipulate information or data from at least one transmitter to at least one receiver. As such, the communication may include a range of systems supporting point-to-point or broadcasting of the information or data. A communication system may refer to the collection individual communication hardware as well as the interconnects associated with and connecting the individual communication hardware. Communication hardware may refer to dedicated communication hardware or may refer a processor coupled with a communication means (i.e., an antenna) and running software capable of using the communication means to send and/or receive a signal within the communication system. Interconnect refers some type of wired or wireless communication link that connects various components, such as communication hardware, within a communication system. A communication network may refer to a specific setup of a communication system with the collection of individual communication hardware and interconnects having some definable network topography. A communication network may include wired and/or wireless network having a pre-set to an ad hoc network structure.

The term “computer-readable medium,” as used herein refers to any tangible storage and/or transmission medium that participates in providing instructions to a processor for execution. Such a medium may take many forms, including but not limited to, non-volatile media, volatile media, and transmission media. Non-volatile media includes, for example, non-volatile random access memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a compact disc read only memory (CD-ROM), any other optical medium, punch cards, paper tape, any other physical medium with patterns of holes, a random access memory (RAM), a programmable read only memory (PROM), and erasable programmable read only memory EPROM, a FLASH-EPROM, a solid state medium like a memory card, any other memory chip or cartridge, a carrier wave as described hereinafter, or any other medium from which a computer can read. A digital file attachment to an e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. It should be noted that any computer readable medium that is not a signal transmission may be considered non-transitory. The computer-readable medium may be physical in nature or virtual residing within a cloud environment.

The term “module” as used herein refers to any known or later developed hardware, software, firmware, artificial intelligence, fuzzy logic, or combination of hardware and software that is capable of performing the functionality associated with that element.

The term “display” refers to a portion of a physical screen used to display the output of a computer to a user. A display can employ any of a variety of technologies, such as liquid crystal display (LED), light-emitting diode (LED), organic LED (OLED), active matrix OLED (AMOLED), super AMOLED, microelectro mechanical systems (MEMS) displays (such as Mirasol® or other interferometric display), and the like.

The terms “determine,” “calculate,” and “compute,” and variations thereof, as used herein, are used interchangeably and include any type of methodology, process, mathematical operation, or technique.

The term “in communication with,” as used herein, refers to any coupling, connection, or interaction using electrical signals to exchange information or data, using any system, hardware, software, protocol, or format, regardless of whether the exchange occurs wirelessly or over a wired connection.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

### BRIEF DESCRIPTION OF THE DRAWINGS

The accompanying drawings, which are incorporated in and constitute a part of the specification, illustrate embodiments of the disclosed system and together with the general description of the disclosure given above and the detailed description of the drawings given below, serve to explain the principles of the disclosed system(s), methods(s) and device(s).

FIG. 1A is a schematic view of a training system according to one embodiment of the present disclosure;

FIG. 1B is a schematic view of another embodiment of a training system of the present disclosure, the training system associated with a training device for a vehicle;

FIG. 2 is a block diagram of a training system according to one embodiment of the present disclosure;

FIG. 3 is a block diagram of a performance analysis module according one embodiment of the training system;

FIG. 4 is a diagram of an embodiment of a data structure for storing task data;

FIG. 5 is an exemplary user interface of one embodiment generated by the training system of the present disclosure;

FIG. 6 is another embodiment of a user interface;

FIG. 7 is a view of another user interface of the present disclosure;

FIG. 8 is yet another user interface generated by the training system;

FIG. 9 is a flowchart that generally illustrates a method of creating a model of a task; and

FIG. 10 generally illustrates a flowchart for a method of evaluating the performance of a task by a vehicle operator using a training device.

The drawings are not necessarily (but may be) to scale. In certain instances, details that are not necessary for an understanding of the disclosure or that render other details difficult to perceive may have been omitted. It should be understood, of course, that the disclosure is not necessarily limited to the embodiments illustrated herein. As will be appreciated, other embodiments are possible using, alone or in combination, one or more of the features set forth above or described below. For example, it is contemplated that various features and devices shown and/or described with respect to one embodiment may be combined with or substituted for features or devices of other embodiments regardless of whether or not such a combination or substitution is specifically shown or described herein.

The following is a listing of components according to various embodiments of the present disclosure, and as shown in the drawings:

| Number | Component |
|---|---|
| 2 | Vehicle operator (or student) |
| 4 | Instructor |
| 6 | Training device or simulator |
| 7 | Enclosure or cabin |
| 8 | Control system |
| 10 | Display system |
| 12 | Controls |
| 14 | Sensor |
| 16 | Motion element |
| 18 | Audio element |
| 20 | Training system |
| 22 | Bus |
| 24 | CPU |
| 26 | Input devices |
| 28 | Output devices |
| 30 | Storage devices |
| 32 | Computer readable storage media reader |
| 33 | Application programming interface |
| 34 | Communication system |
| 36 | Working memory |
| 38 | Processing acceleration unit |
| 40 | Database |
| 42 | Task Database |
| 44 | Operator Database |
| 46 | Network |
| 48 | Remote storage device/database |
| 49 | Remote computer |
| 50 | Operating system |
| 52 | Other code |
| 60 | Performance analysis module |
| 62 | Task module |
| 64 | Evaluation module |
| 66 | Prediction module |
| 68 | Recommendation module |
| 70 | Persona Identification module |
| 72 | Report module |
| 80 | Data file |
| 82 | Task |
| 84 | Task identifier |
| 86 | Start feature or criteria |
| 88 | End feature or criteria |
| 90 | Feature |
| 92 | Feature weight |
| 94 | Ellipse |
| 100 | User interface |
| 102 | Buttons |
| 103 | Icon |
| 104 | Summary field |
| 105 | Score |
| 106 | Training tasks field |
| 108 | Details field |
| 110 | Student value |
| 112 | Baseline value |
| 114A | First field |
| 114B | Second field |
| 116 | Score bar |
| 118 | Task analysis field |
| 120 | Factors field |
| 122 | Graph |
| 124 | Event points |
| 126 | Event label |
| 128 | Task criteria |
| 130 | Factors |
| 132 | Summary field |
| 134 | Session score field |
| 136 | Training task field |
| 138 | Student list field |
| 140 | Method of creating a model of a task |
| 142 | Receive data |
| 144 | Create a model of the task |
| 146 | Assign a weight to the task |
| 148 | Identify a feature of the task |
| 150 | Method of evaluating performance of a task |
| 152 | Receive data |
| 154 | Identify a task |
| 156 | Compare performance to model of task |
| 158 | Identify a reason for a deviation |
| 160 | Provide a recommendation |
| 162 | Generate a user interface |

### DETAILED DESCRIPTION

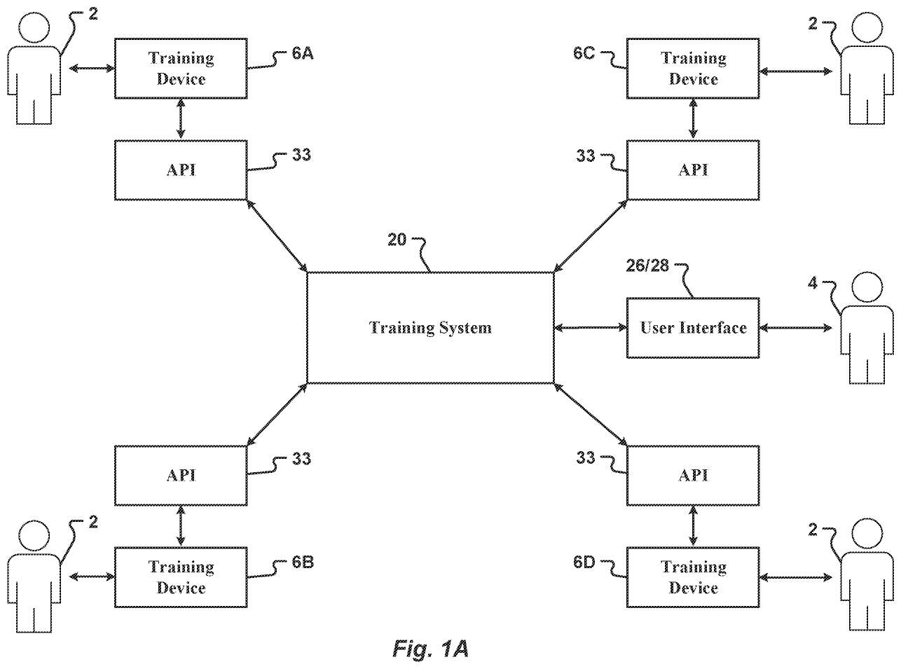

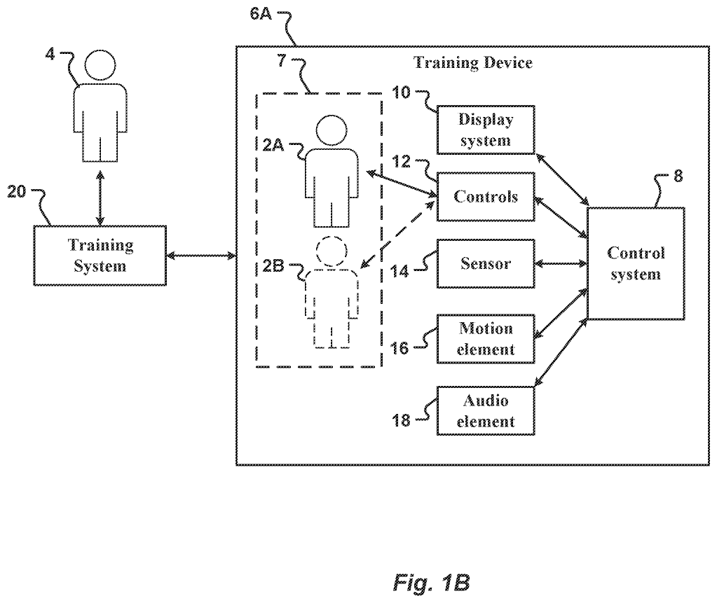

Referring now to FIG. 1A, a training system 20 according to one embodiment of the present disclosure is generally illustrated. The system 20 evaluates performance of a vehicle operator or student 2 during a session at a training device 6. Using data received from the training device 6 and other sources, the system 20 provides objective evaluation, predicts performance, and provides adaptive learning to students 2 receiving technical training.

The system 20 of the present disclosure can be used with any type of training device 6 designed to train a student 2 operate or service a piece of equipment of any type. For example, the system 20 may be in communication with a training device 6 configured to train a student 6 to operate or service a vehicle. The training device 6 may be a simulator configured to replicate the performance of any type of vehicle.

The training system 20 may be in communication with one or more different training devices 6. The training device 6A is configured to train a student 2 operate an aircraft. In one embodiment, the training device 6A is a simulator, such as a flight simulator configured to replicate operation of an aircraft.

Additionally, or alternatively, the training device 6B may be configured to train a student 2 to operate a terrestrial vehicle or piece of machinery, such as a car, a truck, a tracked vehicle, a military vehicle, or a train. Other types of training devices 6C, 6D may also communicate with the training system 20. For example, the training device 6C is adapted to train a student 2 to operate a water vessel such as a ship or a submersible watercraft (including a submarine). In one embodiment, the training device 6D is configured to train a student 2 to operate a spacecraft or a satellite. Additionally, or alternatively, the training device 6D may be configured to train the student to operate a system for a space launch vehicle. As will be appreciated by one of skill in the art, training devices 6 associated with the training system 20 can be configured to train students to work on or operate other types of machinery and equipment, whether the machinery is mobile (as in a vehicle) or stationary.

The training devices 6 may communicate with the training system 20 over a network connection. In one embodiment, the training devices 6 connect to an application programming interface (API) 33 of the training system 20. As will be appreciated by one of skill in the art, the API 33 facilitates communication between the training devices 6 and the training system 20. The API defines interactions between the training devices 6 and the training system 20.

Optionally, a training device 6 may be located in a classroom. For example, a student 2 may be one of a plurality of students 6 attending a class with an instructor or instructor 4. In one embodiment, the instructor 4 may be remotely located. In another embodiment, the training device 6 is a personal computer and the student 2 is enrolled in an eLearning or computer-based training (CBT) course.

Referring now to FIG. 1B, the training system 20 is generally illustrated in communication with the training device 6A according to one embodiment of the present disclosure. The training device 6A is configured provide technical training to a student 2 to operate a vehicle, such as an aircraft. In one embodiment, the training device 6A is a flight simulator.

Optionally, the training system 20 communicates with the simulator 6A using a network connection. Although only one simulator 6A is illustrated in FIG. 1B, the training system 20 can be in communication with and receive data from any number of simulators 6A. Further, the training system 20 may be in communication with simulators 6A of different types configured to train students 2 to operate various aircraft, including fixed wing aircraft, helicopters, and remotely piloted vehicles. In one embodiment, the training system 20 controls the simulator 6A.

The operator may be a student 2 in a training session learning to operate a vehicle. However, the training system 20 can also be used to evaluate the performance of an experienced or qualified operator 2 of the vehicle. The training device 6 may have positions for two or more students 2A, 2B. Additionally, although the operator or instructor 4 is illustrated as being outside the training device 6A, in one embodiment the operator 4 is positioned within the training device.

Training devices 6 of all embodiments of the present disclosure generally include a control system 8. The control system 8 includes a processor, a memory, and instructions stored in the memory that cause the processor to operate the training device 6. The control system 8 can be a laptop computer, netbook computer, a personal computer (PC), a desktop computer, or any other programmable device operable to store and execute the simulator instructions. In one embodiment, the control system 8 is included in the training system 20. In another embodiment, the training system 20 can control the control system 8.

As generally illustrated in FIG. 1B, training devices 6 of the present disclosure can also include, but are not limited to, one or more of a display system 10, controls 12, a sensor 14, a motion element 16, and audio equipment 18 that are in communication with the control system 8. The display system 10 receives signals from the control system 8 and provides information to the student 2. In some embodiments, the training device 6 is a simulator for a vehicle. In these embodiments, the display system 10 provides a realistic view of a virtual environment outside the vehicle as would be seen by the student 2 when looking through a window of the vehicle.

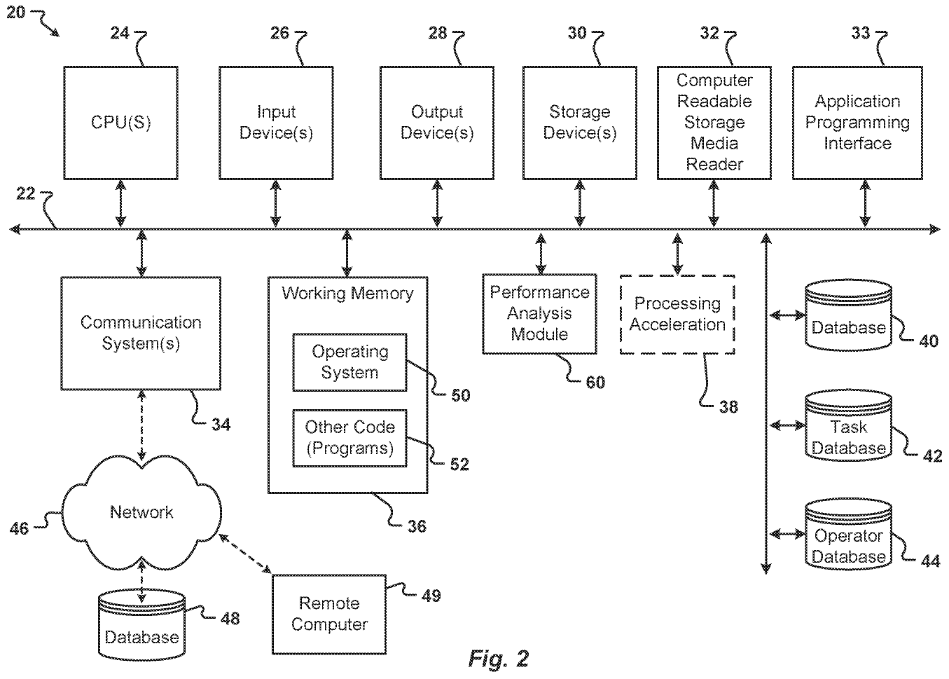

The display system 10 may include a projector, an optical element (such as a lens and/or a mirror), and a display screen. The display screen may be transparent. Optionally, a surface of the display screen may be reflective or mirrored. Some display screens of training devices 6 substantially surround the student 2 to provide an immersive training experience. For example, the display screen may extend 120° or more around the student 2. Optionally, the display screen extends above the student. In one embodiment, the display screen of the display system 10 includes a dome or portion of a sphere on which images are projected. Alternatively, the display screen may be substantially flat or planar. In one embodiment, the display screen of the display system 10 is an output device or screen 28 such as described in conjunction with FIG. 2.

The training device 6 may also include a display screen associated with the display system 10 to replicate the appearance of a portion of an interior of the vehicle. For example, the training device may include a first display screen to show objects outside a window of the vehicle and a second display screen to show objects within the vehicle to the student 2.

Optionally, the display can include one or more flat panel displays including LCD displays and the like. Some display screens of the display system 10 may be touch sensitive to receive inputs from the student 2. The display system 10 may also include a display screen associated with a helmet or other headgear worn by the student.

The display system 10 may also include a display screen to replicate instruments that provide information to the student 2. For example, a display screen may be part of an instrument panel or console within the training device 6. The display screen of the console can include instruments that provide information to the student 2 on the performance of systems of the vehicle, such as operation of an engine (including RPMs, fuel consumption, throttle setting, etc.), as well as information about the position of the vehicle including its orientation, altitude, velocity, climb rate, and the like.

The training device 6 also includes controls 12 that are the same as, or similar to, the controls of the vehicle the student 2 is learning to operate and which the training device replicates. In some training devices 6, the controls 12 include a throttle and a steering element. However, as will be appreciated by one of skill in the art, training devices may have any number and type of controls 12. Depending upon the type of vehicle the training device replicates, the controls may include a stick, a yoke, a wheel, rudder pedals, foot or toe brakes, a gear handle, a flap handle, an engine condition lever, a transmission level or shifter, and a clutch as well as various input devices such as pointers, a mouse, a keyboard, a touch screen, buttons, switches, knobs, levers, sliders, wheels, and the like.

A control 12 may be included as part of the display system 10. For example, the controls 12 may include virtual buttons, knobs, or levers projected in a display screen of the display system 10 of the training device 6. The display screen may be touch sensitive to receive a touch input from the student operator 2. Optionally, some controls 12 of the training device can be manipulated or actuated by gesture inputs or voice commands of the student 2. For example, some vehicles include helmet mounted sights or cueing systems that can be operated by movement of the eyes of the student operator and used to select or actuate a control 12. Additionally, or alternatively, cameras or other sensors 14 may be included in the enclosure 7 to record a gesture of an operator 6 to manipulate or actuate a control 12.

The controls 12 are configured to receive input from the student 2. Some simulators 6 include separate or duplicate controls 12 for one, two or more operators 2A, 2B.

The controls convert the input and/or force from the student into a signal that is transmitted to the control system 8. In some embodiments, the training device 6 includes a simulator program stored in the memory of the control system 8. The control system receives the inputs to the controls 12 from the student and then the simulator program changes the output of the display system 10 (including the instruments if necessary) to emulate the reaction of the vehicle to the student's input.

Some training devices 6 include controls to receive input from the instructor 4. The instructor 4 may also use an input device 26 of the training system 20 to control performance of the training device 6. More specifically, the instructor 4 can start, stop, or alter operation of the training device 6 and a simulation being executed by the training device during a training session. In some embodiments of training devices 6, the instructor 4 can select a task for the student 2 to perform.

The training device 6 can include one or more sensors 14 that record information during a training session, such as during performance of a task by the student 2. The sensors 14 can distinguish between inputs or actions of a first student 2A and a second student 2B.

Any type of sensor 14 can be used with the simulator. For example, the training device 6 may include a motion sensor to detect motion and/or movement of the student within an enclosure 7 of the training device 6. Optionally, the path, trajectory, anticipated path, and/or some other direction of movement/motion may be determined by the control system 8 using data received from a motion sensor 14. In some training devices, the motion sensor 14 may be used to receive gesture or hand inputs from the student 2. Accordingly, in some embodiments, the control system 8 includes gesture capture and recognition software or modules.

The motion sensor 14 may be an optical or image sensor, such as a camera. Optionally, the camera may record still images, video, and/or combinations thereof.

The training device may also include a biometric sensor to identify and/or record characteristics associated with the student 2. The biometric sensors 14 can include one or more of an image sensor, an IR sensor, fingerprint readers, weight sensors, load cells, force transducers, heart rate monitors, blood pressure monitors, temperature monitors, and the like. A sensor in a seat of the simulator may also provide biometric data (e.g., weight, weight shifts, etc.) of the operator.

In some embodiments, the biometric sensors 14 collect or perform one or more of an electroencephalogram (EEG), an electrocardiogram (ECG), an electromyography (EMG), electrodermal activity (EDA), and galvanic skin response (GSR) on the student 2. A biometric sensor 14 may also collect data on facial expressions of the student.

The training device 6 optionally includes a biometric sensor 14 to track and record data on the movement of the eyes of the student 2. For example, the biometric sensors 14 can record the orientation of the student's head, the orientation of the eyes, and a focal point of the eyes of the student. In this manner, the control system 8 can determine objects that the student focused on (or observed) during a session in the training device 6. The biometric data collected by the sensors 14 can be used by the control system to determine which objects (such as instruments, controls 12, and virtual items projected by the screens of the display system 10) the student observed, when the student observed the object, and how much time the student 2 devoted to the object.

In one embodiment, the control system 8 can generate a “heat map” indicating objects the student 2 observed. As will be appreciated by one of skill in the art, a heat map is a method of organizing data by a magnitude or frequency of an activity. The heat map may include a visual representation on a display.

The heat map may indicate the amount of time the student observed each object. Optionally, the heat map may include the frequency the objects were observed by the student. Additionally, or alternatively, the heat map can show the order or sequence in which the student observed objects. For example, the control system 8 can indicate patterns, order, and time spent by the student observing objects. In this manner, training system 20 can identify objects the student spent too much, or too little, time observing.

The training system 20 can also identify objects the student did not observe by analyzing biometric data from the biometric sensors 14. For example, the training system 20 may identify an instrument, gage, object, or piece of information shown on a display 10 that the student should have observed during performance of a task. In this manner, the training system 20 can identify a root cause for failure to adequately perform a task if the student 2 did not look at an instrument or see information displayed by the display system 10 that is necessary to complete the task.

The biometric sensors 14 provide information that is useful for providing a holistic evaluation of student performance. Data from the biometric sensors 14 may be used to determine a root cause when the student receives a deficient score for a task executed during a training session. The biometric sensors 14 may also provide data which indicates a human factor and/or human-machine interface (HMI) issue interfering with training or that contributed to the deficient score.

Audio sensors 14 may also be included in the training device 6. The audio sensors 14 may be configured to receive audio input from the student 2 and/or an instructor 4. The audio input from the student may correspond to voice commands, conversations detected in the training device, simulated radio transmissions, and/or other audible expressions made in the training device. The audio sensors may optionally include a microphone, an analog to digital converter (ADC), a memory, and/or and embedded processor. The audio data collected by the audio sensors can be transcribed by a voice recognition module of the control system 8.

The training system 20 can use audio information from the audio sensors 14 to automatically assess communication effectiveness of a student 2. Additionally, or alternatively, the audio information may be useful to evaluate coordination dynamics between a first student 2A and a second student 2B or between a student 2 and another person, such as a controller or instructor 4. The training system 20 may determine a student 2 was distracted by noises or communication detected by the audio sensors. In this manner, the training system 20 may attribute a deficient score on a task executed by a student 2 to distraction. If the student 2 fails to acknowledge a verbal instruction (such as a simulated instruction from a controller) or a warning (for example, an emergency warning generated by the training device 6), the training system 20 may attribute a deficient score for a task to a failure of the student to receive or understand the instruction or warning.

In one embodiment, the training system 20 analyzes non-verbal cues included in the audio information. For example, the training system 20 can analyze a tone of voice of the student 2. The training system 20 may use the audio information to evaluate one or more of effort levels between two students, speaker ratio (turn taking and/or silence) between two students, speaker overlap, and workload flags. In this manner, the training system 20 may rate social hierarchy and performance of a crew during a training session. The audio information may also be used to evaluate crew resource management (or cockpit resource management) (CRM) based on interpersonal communication, leadership, and decision making exhibited by a crew training with the training device 6.

The training device 6 can also include sensors 14 to measure forces applied by the student 2 to the controls 12. In this manner, the control system 8 can receive data related to the amount of force applied by the student 2 to the controls. Further, the force sensors 14 can distinguish between inputs of a first student 2A and a second student 2B. This allows the training system 20 to accurately attribute a root cause of a deviation from acceptable performance of a task to an action (or inaction) of either the first student 2A, the second student 2B, or both students 2A, 2B.

The force sensors 14 can measure one or more of a magnitude of the force, a start time associated with initiation of the force, a duration of the application of the force, changes in the magnitude over time, and an end time recorded when the student stops applying the force to a control 12. In one embodiment, the force sensors 14 include load cells, force transducers, weight sensors, accelerometers, damped masses, magnets, and the like. The force sensors are configured to covert measured forces (e.g., force, weight, pressure, etc.) into output signals that are transmitted to the control system 8.

The training device 6 can also include a motion element 16. The motion element 16 is adapted to move an enclosure or a cabin 7 of the training device 6 to replicate motion of the vehicle. In some training devices 6, the motion element 16 can move the enclosure 7 or a station or a seat for the student 2 in one or more of a pitch orientation, a roll orientation, and a yaw orientation as will be appreciated by one of skill in the art. The control system 8 can send signals to the motion element 16 to move the cabin 7 in response to input to the controls 12 received from the student operator.

Some training devices 6 have an audio element 18 which provides sounds the student would hear during operation of the vehicle. The audio element 18 may produce audio warnings or alarms during the training session. In one embodiment, the audio element 18 includes an amplifier and a speaker. In some embodiments, biometric sensors 14 of the training device 6 can collect data on the student's reaction to an alarm or alert generated by the audio element.

Referring now to FIG. 2, an embodiment of a training system 20 of the present disclosure is generally illustrated. More specifically, FIG. 2 illustrates one embodiment of a training system 20 of the present disclosure operable to receive data from a training device 6 and evaluate a student 2. In one embodiment, the training system 20 is configured to control the training device 6.

The training system 20 is generally illustrated with hardware elements that may be electrically coupled via a bus 22. The hardware elements may include one or more central processing units (CPUs) 24; one or more input devices 26 (e.g., a mouse, a keyboard, etc.); and one or more output devices 28 (e.g., a display device, a printer, etc.). The training system 20 may also include one or more storage devices 30. In one embodiment, the storage device(s) 30 may be one or more of disk drives, optical storage devices, and a solid-state storage device such as a random access memory (“RAM”) and/or a read-only memory (“ROM”), which can be programmable, flash-updateable and/or the like.

The training system 20 may additionally include one or more of a computer-readable storage media reader 32; a communications system 34 (e.g., a modem, a network card (wireless or wired), an infra-red communication device, etc.); and working memory 36, which may include RAM and ROM devices as described above. In some embodiments, the training system 20 may also include a processing acceleration unit 38, which can include a DSP, a special-purpose processor and/or the like.

The training system 20 optionally includes a database 40. The database 40 may be used to store courseware and lesson plans associated with a course for a student 2.

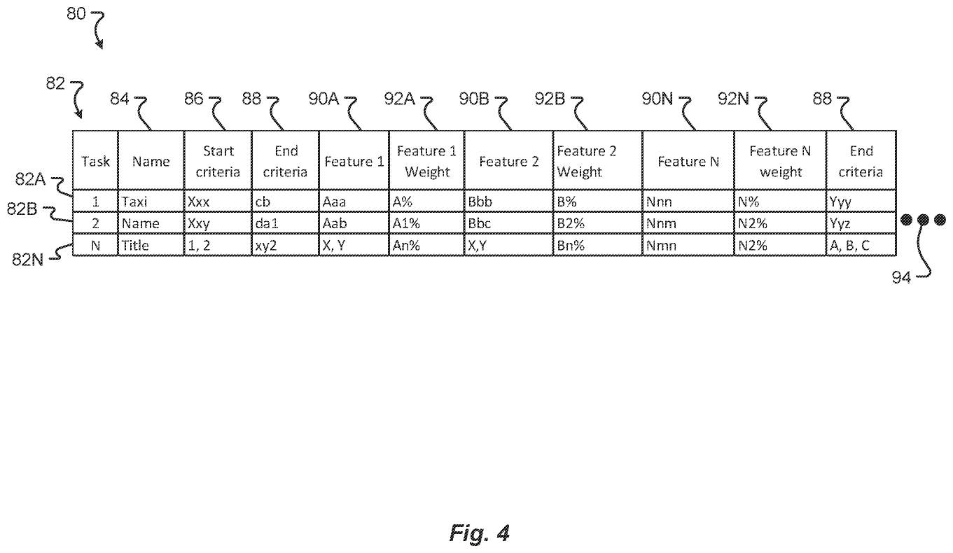

In one embodiment, the training system 20 includes a task database 42. The training system 20 can store tasks 82 to be performed by the student 2 in a data file 80 of the task database 42 (as generally illustrated in FIG. 4). Additionally, or alternatively, the tasks 82 are stored in one or more of the local database 40 and a remote database 48. The tasks may be entered by a user. Additionally, or alternatively, the tasks 82 can be created by the training system 20 as described herein.

The tasks 82 are related to the type of vehicle (ship, aircraft, wheeled vehicle, etc.) and may be varied based on a model or manufacturer of the vehicle (for example, tasks for a Boeing 787 may be different than tasks for a Boeing 737 or for an Airbus A380). Moreover, tasks for an aircraft (such as a Boeing 737) may vary based on a model number, the manufacturer of its engines, optional equipment installed on the aircraft, and other factors.

For a flight simulator 6A emulating an aircraft, the tasks are related to any phase of operation of the aircraft, such as pre-flight operations, ground operations, taxi, take-off, climb, cruise, descent, approach, and landing. Further, the tasks may include emergency procedures, standard operating procedures, and competencies.

The tasks 82 can be organized by a type of maneuver and variations of the maneuver. For example, tasks for operation of an aircraft may include landings, takeoffs, approaches, and stall recovery. Each of these tasks may include related conditions or features 90 affecting the task 82, such as a crosswind landing, a one-engine inoperable landing, a touch-and-go landing, a zero-flap landing, etc.

Each task 82 can include one or more features 90. The features 90 of a task may include a parameter or condition of the vehicle during the task. For example, a feature 90 can describe an attitude of the vehicle at various times during the task, such as the pitch, the yaw, and the roll of the vehicle. One feature may describe the position and/or performance of the vehicle, including the altitude, heading, climb (or descent) rate, airspeed, and forces on the vehicle. Another feature may describe settings of control elements of the vehicle, including settings for landing gear, flaps, ailerons, slats, rudders, elevators, stabilizers, air brakes, and the like. The features can also relate to positions or inputs to controls, including positions of a stick or wheel, rudder pedals, brakes, throttle settings, forces applied to the controls, etc. One feature may relate to operation of the vehicle, including engine performance, engine RPMs, engine temperature, fuel level, weight, balance, at others. Additionally, or alternatively, a feature may also describe a sequence or timing of operations performed during execution of the task.

If a student 2 performs a task and the student does not perform an action required by a feature of the task, the training system 20 may assign a grade of deficient to the student. The grade may be based on the magnitude of the variation from the standard for the features set by the training system. For example, if the attitude of the vehicle varies by more than a predetermined amount from a required attitude, the training system 20 may assign a deficient grade for the task, or for at least the feature. More specifically, if the pitch, the yaw, or the roll during a task is not within a predetermined range, the training system 20 may assign a deficient grade for the task. Similarly, if the student does not comply with a feature defining a position or a performance of the vehicle, a feature for control elements of the vehicle, a feature defining positions or inputs to controls, or a feature for operation of the vehicle, the training system 20 can assign a deficient grade for the task and/or the feature.

The tasks 82 can be based on regulations or laws created by a government entity, regulatory entity, or a licensing authority. Moreover, the tasks may come from guidance or publications generated by commercial, government, military, or international organizations. For example, the tasks may be based on requirements published by the U.S. Federal Aviation Administration, the U.S. Department of Transportation, the U.S. Department of Defense, the U.K. Civil Aviation Authority, the European Union Aviation Safety Agency, the International Civil Aviation Organization, and others. The tasks 82 can also come from a syllabus or training plan required for operation of the vehicle. The syllabus may include a lesson plan comprising the tasks. The lesson plan may include a rule. The lesson plan may also include a training point and/or a Key Performance Indicator (KPI). A training point may correspond to an event, a rule, and/or a value of a rules or of events.

A task 82 may also include a standard or criteria for grading performance of the task. The standard or criteria may be established by a commercial, government, military, or international organization. In one embodiment, the training system 20 may retrieve a task 82 or a feature 90 from an external source over the network 46.

The training system 20 may also include an operator database 44. The operator database 44 stores data collected when vehicle operators (including students 2) perform a session in a training device 6. The operator database 44 may include fields for: a name of the operator; a unique identifier associated with the operator; an identifier for a type of vehicle associated with the operator; an identifier for a class to which the operator is assigned; an employer or sponsor of the operator; a predicted probability of successful completion of a syllabus by the operator; an estimated time to completion of the syllabus; recommended tasks for the operator; a record of each training session executed by the operator; a field for each task executed by the operator during a training session; a score for each task; data collected by sensors 14 of the training device during a training session executed by the operator; a list of instructors 4 that have conducted training sessions with the operator 2; an identifier for each training device 6 in which the operator has had a training session; and an overall rating or score of the operator. In some embodiments, the data in the operator database 44 may be anonymized to protect the privacy of individual operators.

The computer-readable storage media reader 32 can further be connected to a computer-readable storage medium, together (and, optionally, in combination with storage device(s) 30) comprehensively representing remote, local, fixed, and/or removable storage devices plus storage media for temporarily and/or more permanently containing computer-readable information. The communication system 34 may permit data to be exchanged with a network 46 and/or any other data-processing.

The network 46 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 46 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

Optionally, the training system 20 may access data stored in a remote storage device, such as database 48 by connection to the network 46. The remote database 48 may be a cloud-based storage system. In one embodiment, the network 46 may be the internet.

Optionally, the training system 20 may connect to a remote computer 49 using the network 46. The remote computer 49 may be a cloud computing service. For example, the remote computer 49 may provide one or more of software as a service, platform as a service, infrastructure as a service, storage, data management, messaging, media services, and a content delivery network for audio, video, applications, images, and static files to the training system 20. In one embodiment, the remote computer 49 is a commercial product, such as Microsoft Azure Cloud. Other suitable systems that may be used as the remote computer 49 are known to those of skill in the art.

The training system 20 may also comprise software elements, shown as being currently located within the working memory 36. The software elements may include an operating system 50 and/or other code 52, such as program code implementing one or more methods and aspects of the present invention. In one embodiment, the working memory 36 or other code 52 includes instructions that cause the CPU 24 to operate a training device 6. The training system 20 also includes a performance analysis module 60.

One of skill in the art will appreciate that alternate embodiments of the training system 20 may have numerous variations from that described above. For example, customized hardware might also be used and/or particular elements might be implemented in hardware, software (including portable software, such as applets), or both. Further, connections to other computing devices such as network input/output devices may be employed.

In one embodiment, the training system 20 is a personal computer, such as, but not limited to, a personal computer running the MS Windows operating system. Optionally, the training system 20 is a tablet computer, a laptop computer, and similar computing devices. In one embodiment, the training system 20 is a data processing system which includes one or more of, but is not limited to: at least one input device (e.g. a keyboard, a mouse, or a touch-screen); an output device (e.g. a display, a speaker); a graphics card; a communication device (e.g. an Ethernet card or wireless communication device); permanent memory (such as a hard drive); temporary memory (for example, random access memory); computer instructions stored in the permanent memory and/or the temporary memory; and a processor.

The training system 20 is in communication with the control system 8 of the training device 6. Optionally, the control system 8 of the training device 6 is included with the training system 20. Additionally, or alternatively, the training system 20 can receive information from and send commands to other elements of the training device 6, such as the display system 10, controls 12, sensor 14, motion element 16, and audio element 18.

Optionally, the training system 20 can send instructions to components of the training device 6. For example, the training system 20 can send a command to the control system 8 that causes the training device 6 to change output of a display screen of the display system 10. In this manner, the training system 20 can cause the training device 6 to present a task for the operator/student 2 to perform, such as a movement of the vehicle including a turn, takeoff, landing, taxing, and others.

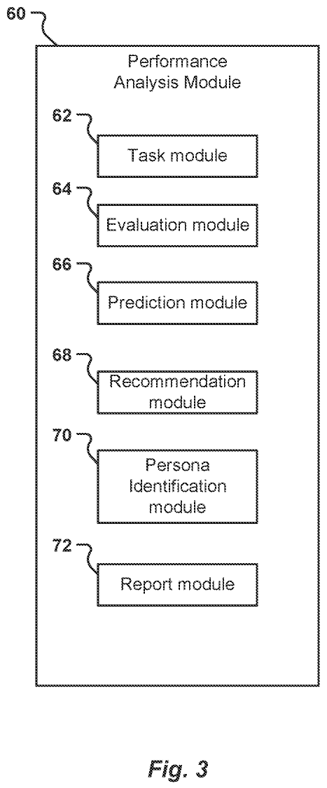

Referring now to FIG. 3, elements or modules of the performance analysis module 60 are generally illustrated. The performance analysis module 60 can include any number of software or hardware elements or modules. Optionally, the performance analysis module 60 includes one or more of a task module 62, an evaluation module 64, a prediction module 66, a recommendation module 68, a persona identification module 70 and a report module 72.

The task module 62 stores and/or revises information about tasks for vehicles and other types of equipment in a data file 80 (shown in FIG. 4) stored in one or more databases, such as the task database 42, the local database 40 or the remote database 48. As will be appreciated by one of skill in the ark, the data stored in the databases may be encrypted.

In one embodiment, the task module 62 can identify tasks 82 to be performed by an operator 2, such as a student. Additionally, or alternatively, the task module 62 can create one or more features (or parameters, or variables) 90 for each task 82. When the operator 2 performs the task, the training system 20 evaluates the operator's performance of the task 82 and its features 90.

The task module 62 reviews task data collected by the training device 6 during a training session performed by an operator 2. The task module can determine patterns and variables in the task data from multiple operators. The task data is then automatically categorized according to the patterns and variables into a set of training tasks.

In one embodiment, the task module 62 uses machine learning to identify features 90 for the tasks and to create a model of the task. As will be appreciated by one of skill in the art, machine learning involves algorithms that learn from and can make predictions about data. The task module may use one or more machine learning techniques such as supervised, unsupervised or semi-supervised learning to build the model of the task.

Employing machine learning, in some embodiments the task module 62 uses task data to build a model of the task, the task data collected from operators 2 performing tasks using a training device 6. The task data includes inputs to the controls 12 from operators performing the task. Data collected by the sensor 14 of the training device 6 may also be used by the task module 62 to build the model.

The task data can be stored in one or more databases accessible by the training system 20. For example, the task module 62 can retrieve the task data from a database of the training system 20, such as one or more of databases 40, 42, 48. Task data stored in the operator database 44 (if any) can also be used by the task module 62.

In one embodiment, the task module 62 creates clusters from the task data. The task module may also categorize the task data by assigning data from each operator performing the task to a cluster. Regression analysis may also be performed on the task data by the task module 62. In one embodiment, the task module 62 performs regression analysis on each cluster.

The task module 62 can create one or more models of each task. For example, in one embodiment, the task module 62 can create a first model of a task using data collected as operators 2 who are proficient operators of the vehicle perform the task 82. A proficient operator is one who is licensed or otherwise certified to operate the vehicle. In this manner, the evaluation module 64 can assess the performance of a task by an operator 2, such as a student, compared to how proficient operators execute the task. Optionally, the task module 62 can create a second model of the task 82 from data collected as operators 2 who are not proficient (such as student operators of the vehicle) perform the task. This facilitates comparison of a non-proficient operator 2 (such as a student) to other students.

Additionally, or alternatively, the task module 62 can create a third model of the task 82 with data collected from all operators of any skill level who perform the task in the training device 6. In one embodiment, the task module 62 updates or revises one or more of the models whenever an operator 2 conducts a training session and performs a task.

The tasks 82 may be assigned different levels of importance. For example, some tasks 82 may be required to pass a training course for operation of a vehicle. Accordingly, if a vehicle operator 2 deviates from a standard for the task 82 defined by the task model, the operator may be assigned a failing grade for the training session. Other tasks may be of a lower importance.

The features 90 for each task 82 may be assigned a weight 92 or importance by the task module 62. In one embodiment, some task features have weights that are different than other task features. In this manner, the task module 62 can assign a first weight 92A to one feature 90A and a second weight 92B to another feature 90B, the first weight being the same as, equal to, or different from the second weight.

In one embodiment, the task module 62 identifies a start feature 86 and an end feature 88 for each task. The start and end features generally include information and/or objective criteria that can be used to identify when a vehicle operator 2 starts and stops a task 82 in the training device 6. Each task may have a plurality of features 90A . . . 90N that occur between the start feature 86 and the end feature 88. All features of a task may be separately graded or evaluated by the performance analysis module 60. The training system 20 can use the start 86 and end 88 features to automatically identify when an operator conducts a task 82 based on data received from the training equipment 6. In this manner, the instructor 4 does not have to make an entry in a record or make an input to the control system 8. Instead, the training system 20 can automatically evaluate the performance of the task by a student operator 2.

Referring now to FIG. 4, a data structure 80 to store tasks 82 is generally shown. The data structure 80 may include several portions or columns representing different types of data. Each of these types of data may be associated with a task 82. There may be any number of tasks 82A, 82B . . . 82N in the data structure 80. Each task may have a name or other identifier 84. The tasks each have a start feature or criteria 86, an end feature or criteria 88, and at least one feature 90A . . . 90N that occurs between the start and end features. Each feature 90 of a task 82 can have an importance or weight 92A . . . 92N. Two features may have the same or a different weight. The data file 80 may include any number of additional data columns for different types of data as indicated by ellipses 94.

Referring again to FIG. 3, the evaluation module 64 of the training system 20 compares data collected as an operator or a student 2 performs a task 82 to a preferred result of the task. In one embodiment, the evaluation module 64 uses a model of a task 82 created by the task module 62 to evaluate the operator 2 using data collected as the operator performs the task. The training system 20 can also use the model to predict how the operator (or a student) will perform in a course training the student to operate the vehicle.

The evaluation module 64 is operable to provide an objective rating of a task 82 executed using the training device 6 by an operator 2, including by a student. In one embodiment, the evaluation module 64 compares task data of the operator 2 collected during a training session to a model of a task created by the task module 62. The comparison by the evaluation module 64 can include evaluation of features 90 of the task 82 performed by the operator. The evaluation module 64 can compare the performance of the task by the operator 2 over time to the model of the task created by the task module 62.

In one embodiment, the evaluation module can rate the performance of the operator 2 during a training session by comparing the performance of parameters of a task executed by the operator against a baseline for the task created by the task module. Optionally, the evaluation module can provide a numerical score, such as from 0 to 100, to each task conducted by the operator.

Optionally, the evaluation module 64 can evaluate and grade an operator's performance in one or more ways. First, the evaluation module 64 can provide a grade for performance of a task compared to a baseline for the task determined by the task module 62. In one embodiment, the baseline is a mean of the task data collected by the training device 6. For this first grade, the evaluation module 64 includes an algorithm that compares the operator's handling of the vehicle to the baseline. This includes overlaying data from sensors 14 collected as the operator performs the task over the baseline. The evaluation module then measures the similarity of the sensor data to the baseline. In this manner, the evaluation module measures relative performance rather than absolute performance.

Additionally, or alternatively, evaluation module 64 may use a deviation threshold method to evaluate a task performed by an operator. Each task can include a first value for an acceptable amount of deviation from the baseline. A second value for the task may be set for an unacceptable amount of deviation. In this manner, an operator 2 who performs a task 82 with a deviation that is less than the first value will receive a passing score. In contrast, if the operator deviates by more than the second value, the operator will receive a failing score for the task.

In one embodiment, the evaluation module 64 can provide a task score for each task performed by an operator. The task score may include scores for all features or parameters associated with the task. In one embodiment, the task score may be on a scale of 0 to 100, or as a percentage compared to the model for the task. Optionally, the task score comprises an aggregation of the scores of all features of the task.

For each task, the evaluation module 64 can provide a reason for a deviation from a standard for a task performed by the operator 2. For example, for a task 82 associated with operating an aircraft performed during a session in a flight simulator 6A, the evaluation module 64 may determine that the operator did not successfully perform the task because a velocity of the aircraft was too low at a specific time required by a feature 90 of the task 82. An example reason for a deviation may be “Pilot's airspeed was 25.6 knots too low at the time of flap retraction” for a feature of a task associated with an aircraft task known as a “V1 Cut Remediation.”

The evaluation module 64 can use any data collected by a sensor 14 of the training device 6 to evaluate the performance of an operator 2 executing a task. For example, the evaluation module 64 may determine the operator 2 was unfamiliar with the layout of an instrument console of the simulated vehicle based on movement of the student's eyes collected by a biometric sensor 14. In response, the recommendation module 68 may recommend additional familiarization training for the operator.

For training devices 6 with stations for two or more operators 2A, 2B, the evaluation module 64 can distinguish between control inputs made by the first operator 2A and the control inputs made by the second operator 2B. In this way, the evaluation module 64 can determine actions or inaction by the operators 2A, 2B that influenced performance of a task. For example, some tasks require inputs from both operators 2A, 2B. The evaluation module 64 can use the task data collected by the training device 6 and identify inputs (including inadvertent or unintended inputs) of both the first operator 2A and the second operator 2B that affected the outcome of task. For example, the evaluation module 64 can identify an action the first operator 2A took to compensate for or correct an improper or incorrect action of the second operator 2B. Similarly, the evaluation module 64 may determine the first operator 2A made an unintended or inadvertent input to a control 12 that affected performance of a task by the second operator 2B. In still another example, the evaluation module 64 can determine inaction by the first operator 2A influenced the execution of a task by the second operator 2B. In this manner, if a task 82 requires an action by the first operator 2A, the evaluation module 64 may determine the first operator did not successfully perform the task if the first operator does not take the required action. The evaluation module 64 may assign the first operator a failing grade for the task even if the second operator takes the required action to compensate for inaction by the first operator.

Similarly, the evaluation module may determine a first operator successfully performed a task if a second operator makes an input that caused the first operator's performance of the task to deviate from a requirement of a model of the task. Optionally, the evaluation module may not provide a score (or assessment) for a task performed by a first student if an action by a second operator caused a deviation from a requirement of the task. In this manner, the training system 20 will correctly determine a root cause of a deviation and will not penalize a first student for action attributed to a second student.

In contrast, in a prior art simulator, it may not be possible for the instructor 4 to see if each operator is performing the required inputs. The timing of control inputs by each operator may also not be visible to the instructor. The instructor 4 may also fail to observe a control input of one operator that affects the performance of a task by another operator. Accordingly, the instructor 4 in a prior art simulator may not accurately determine why a task was successfully or unsuccessfully executed.

Additionally, or alternatively, the training system 20 may determine the student was distracted during execution of the task based on sensor data. For example, the biometric sensor 14 may indicate the eyes of the student moved erratically during the training session. The training system 20 may also determine that the student 2 did not pay attention to an instrument or object projected by a display screen of the display system 10. Eye tracking by a biometric sensor 14 may be used by the evaluation module 64 to determine that the operator 2 spent more time than a baseline for the task looking within a cabin 7 of the training device than outside the training device. For example, operator may have been focused on the instrument console (the operator was “heads down”) rather than observing something important outside the vehicle. The eye tracking data from a biometric sensor 14 may also indicate the operator 2 did not observe an instrument or other information presented by a display. The evaluation module 64 in this manner may determine a root cause of a task that was not successfully executed is due to a failure to observe (or receive or consider) a required piece of information from an instrument.

In some embodiments, the training system 20 can also use data collected by audio sensors 14, such as microphones, to evaluate the performance of the operator 2. The training system 20 may include voice recognition software or a voice recognition module to convert speech of the operator 2 into signals that may be stored in the operator database 44. In this manner, the evaluation module 64 may consider the tone, pitch, or content of speech of the operator.

The evaluation module 64 can use data collected from multiple training sessions to evaluate the performance an operator 2. The evaluation module 64 may compare the data collected on a first operator 2 to data collected on a second operator. For example, the evaluation module 64 may compare the performance of a first operator to the performance of one or more other operators. The other operators may have a similar experience level (for example, the other operators may be enrolled in the same course as the first operator). Additionally, or alternatively, the other operators may be more experienced than the first operator. The evaluation module 64 may use machine learning to evaluate data collected on the first operator to performance of other operators executing the task.

In one embodiment, the evaluation module 64 can use historical data to identify a pattern and/or errors across multiple training sessions for an operator. With this information, the recommendation module can provide a recommended training plan for a subsequent training session.

The recommendation module 68 may recommend a new training plan (or changes to an existing training plan) for the operator based on one or more of: (1) tasks 82 the operator has already successfully completed; (2) tasks 82 which require the operator's attention; and (3) tasks 82 that similar operators (for example, students in the same course) practiced before successfully completing a task.

In one embodiment, the evaluation module can predict the probability of success of one or more tasks based on the performance of the operator 2 to date. In one embodiment, the performance analysis module 60 and/or the evaluation module 64 will evaluate the operator's historical performance across similar or related tasks 82 and features 90 and identify variables that contribute to successful performance of the task. The performance analysis module will then combine those features with historical training task scores to predict future successful attempts by the operator.

Additionally, or alternatively, the evaluation module 64 can identify a list of tasks the operator has a probability of failing. The list may include any number of tasks. In one embodiment, performance analysis module 60 or the evaluation module 64 may calculate a probability of failure of a task by the operator based on a combined historic success rate of all operators performing the task. The evaluation module 64 can optionally adjust the probably of failure of a task by the operator based on one or more of the operator's past performance and a learning style of the operator.

In one embodiment, the combined historic success rate of the task is calculated for operators based on their experience level. For example, the combined historic success rate for the task may be calculated for operators with low experience (such as students), medium experience (such as proficient operators), and high experience (such as expert operators). In one embodiment, the operators may be grouped into proficient operators and non-proficient operators (such as students) to determine the combined historic success rate for the task. In another embodiment, the combined historic success rate is calculated for operators based on a number of hours of experience operating the vehicle. Accordingly, in one embodiment, the evaluation module 64 calculates a probability of successful completion or failure of a task by an operator based on a historic success rate of operators with the same or similar level of experience performing the task.

In one embodiment, the evaluation module 64 can provide up to five (or more) tasks that the operator 2 has the greatest probability of failing during a training session. Optionally, the recommendation module 68 can use the list to provide remediation action for the operator to take to decrease the probability of failing the tasks in the list.

In one embodiment, the evaluation module 64 can determine a score for a task 82 to indicate the progress of an operator 2 to completing or “mastering” the task 82. The score can be presented as a percentage. For example, a score of 50% would indicate the evaluation module 64 has determined the operator is approximately half-way to successfully completing the task 82. In one embodiment, the evaluation module 64 may also provide a course score to rate the progress of an operator toward completion of a course.

The recommendation module 68 is operable to determine an action for an operator 2 to take to improve performance during execution of a task. More specifically, the recommendation module 68 may include one or more reasons impacting the performance of a task. Additionally, or alternatively, the recommendation module 68 can assign actions for the operator to take based on the operator's 2 performance on a task 82 compared to how the best performers of that task scored. In one embodiment, the operator will receive recommendations to adjust the values of a feature 92 of the task 82 at given times to align the operator's performance of the task 82 to how the best operators performed on that task.

In one embodiment, the recommendation module 68 uses machine learning to compare the task data from an operator 2 to task data stored in memory of other operators who have performed the task in the training device 6. The recommendation module 68 may compare the task data from the operator to the task model created by the task module 62.

Each task 82 may have predetermined recommendations. In one embodiment, the recommendations are based on inputs received from instructors 4. The recommendations may be based on an amplitude of an input to a control 12 (such as too aggressive, too rapid, too frequent, or too heavy) as well as a recommendation related to the frequency of an input (such as too often, to rare, etc.).

In this manner, the recommendation module 68 can provide factors that contributed to a deviation from a standard for a task 82. For example, the recommendation module 68 may determine an input to a control 12 was too aggressive, too rapid, too frequent, or too heavy. Each control input may include a percent by which the operator 2 varied from the standard, such as “25% too aggressive” or “35% to heavy” on the control 12. The recommendation module 68 may also classify operator inputs to a control 12 as being “too timid”, “too rare”, and “too light”. Other descriptions are contemplated for use by the evaluation module 64.

The recommendation module 68 can also provide feedback on which portions (or features 90) of a task 82 the operator 2 should practice to improve execution of the task. In one embodiment, the recommendation module 68 can identify the likelihood of an operator 2 needing additional training sessions (beyond a preset number of sessions for a specific training program) to complete an evaluation.

In one embodiment, the recommendation module can provide one or more reasons that a task 82 executed by an operator 2 deviated from the baseline or model of the task. Optionally, the recommendation module 68 can provide up to three reasons for a deviation from a task standard. Stated otherwise, the recommendation module can identify the top three reasons for failure of a task by an operator.

The recommendation module 68 may provide a list of tasks the operator 2 should perform to improve the operator's proficiency. The recommended tasks can be provided as a list for the operator 2. Optionally, the recommendation module 68 may provide up to five tasks the operator 2 should work on after the operator completes a training session.

In one embodiment, the recommendation module 68 can select tasks to be executed by the operator 2 during a training session. For example, after completing a first task 82 the recommendation module 68 may send a signal to the control system 8 which causes the training device 6 to set up a second task for the operator to perform. In this manner, available time of the training device 6 is used efficiently and the training of the operator can continue without input from the instructor 4. This frees the instructor to continue observing the performance of the operator and providing feedback to the operator.

In one embodiment, the instructor 4 must accept or approve the second task selected by the recommendation module 68 before the training device 6 sets up the second task. Alternatively, the second task selected by the recommendation module 68 is automatically set up (or executed) by the control system 8 without approval of the instructor 4.

Optionally, the recommendation module 68 can provide recommendations for next actions for the operator 2. For example, the recommendation module may provide up to three recommended next actions. In some embodiments, the instructor 4 may select a task to be performed by the operator from a list of at least one task suggested by the recommendation module. In this way, time in the training device is efficiently used practicing tasks the operator 2 needs improve rather than a task the operator has already performed satisfactorily.

Additionally, or alternatively, the recommendation module 68 can provide an alert to an instructor 4 and/or an operator 2 while the operator is in a training session. The alert may include information for the operator 2 to consider when conducting a task. Optionally, the alert can provide information to the instructor 4 on past performance of the task by the operator 2 as well as a predicted score for the task to be performed by the operator. The recommendation module 68 may use historical task data associated with the operator 2 to create the alert. For example, the alert may include a list of factors the operator should consider when executing the task.

In one embodiment, the recommendation module 68 can recommend a change in lessons for the operator. More specifically, if the evaluation module 64 determines an operator 2 is proficient in a first task or would not benefit from repetition of the first task, the recommendation module 68 may substitute a second task in place of the first task. This is beneficial because it keeps the operator challenged and also makes more efficient use of the training device and instructor time.

The recommendation module 68 may also include rules that vary training content or lessons and concepts based on interactions of an operator. In one embodiment, the recommendation module 68 uses information from the persona identification module 70 and/or the prediction module 66 to alter the training for an operator 2.

Optionally, the performance analysis module 60 includes a persona identification module 70 which identifies groups of operators 2 based on their styles of operating a vehicle emulated by a training device 6. The persona identification module 70 may use data clustering and/or data segmentation to identify groups of operators who share similar styles of operating the vehicle. The persona identification module optionally uses machine learning to consider the task data collected as an operator 2 operates a vehicle during a training session. The persona identification module identifies patterns in the task data. Some examples of personas the training system 20 of the present disclosure may identify include, but are not limited to, a reactive persona, an aggressive persona, a risk-taking persona, a calm persona, and a heavy-handed persona.

The operator patterns identified by the persona identification module 70 may not explain an operator's performance during a single training session; however, the patterns can help instructors 4 personalize the training of particular operators 2. For example, when the persona identification module identifies a persona for an operator, an instructor can develop a personalized training program for the operator. Additionally, or alternatively, the recommendation module 68 may use data from the persona identification module 70 to select or recommend courses or tasks for the operator. In this manner, the identification of a persona for a vehicle operator improves training efficiency by enabling the instructor to modify a lesson plan to cater to the operator's strengths and weaknesses.

In one embodiment, the persona identification module 70 can predict the best training for different operator personas (or profiles). In this manner, training for an operator is matched to a learning style of the operator's persona.

In some embodiments, the persona identification module 70 can retrieve data and records about an operator 2 from memory (such as the operator database 40 or other databases 40, 48) when developing a persona for the operator. For example, the persona identification module 70 may retrieve and use information such as one or more of the age of the operator, the education of the operator, the experience level of the operator (such as the number of hours of vehicle (or aircraft) operation experience the operator has completed), and data collected during a training session in a training device 6. After creating a persona for an operator, the persona identification module 70 may save information about the persona in a record of the operator in the operator database 40.

The report module 72 is operable to provide information to operators 2 and instructors 4 both during and after a training session. In one embodiment, the report module 72 can use information from the one or more of the evaluation module, prediction module, recommendation module, and persona identification module to present an alert to an operator during the training session. The alert may, for example, indicate that the operator is deviating from a standard for a task. In addition, the alert may include a recommended action for the operator to take to correct the deviation.

The report module 72 can also generate one or more user interfaces 100 that present data to a user, such as an instructor 4 or an operator 2. The user interfaces 100 can be displayed on an output device 28 of the training system 20 as well as a display screen of the display system 10. Additionally, or alternatively, a user may use a remote device 49, such as a personal computer, a tablet, or a smart phone, to connect to the training system 20 over a network 46 (such as the internet) to receive a user interface 100 generated by the report module 72.

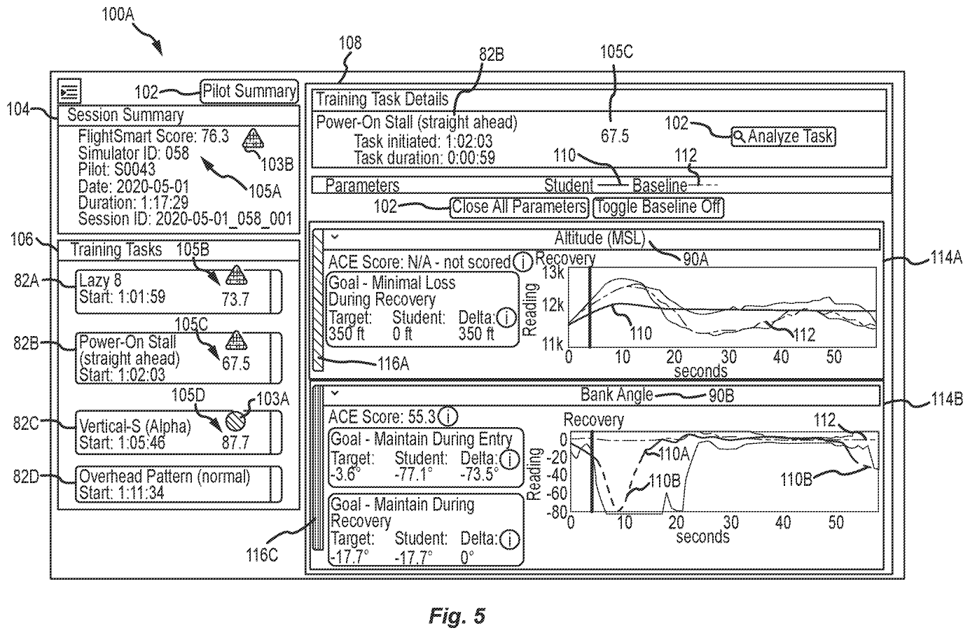

Referring now to FIG. 5, an example of a user interface 100A generated by the training system 20 is generally illustrated. The user interface 100A provides data and an evaluation of a task executed by a student 2 with the training device 6. In this embodiment, the training device 6A is a flight simulator configured to emulate an aircraft. The user interface 100A may include one or more buttons 102 that can be selected by a user to provide additional information.

The user interface 100A includes a summary field 104 which provides data about the student 2 and the training session. The summary field 104 can include one or more of a score or rating 105A for the training session (labeled as “FlightSmart Score” in this example), an identifier for the training device used during the training session (for example, “Simulator ID: 058”), an identifier for the student (labeled as a “pilot” in this example), a date of the training session, a duration of the training session, and a unique identifier of the training session.

In one embodiment, scores 105 displayed by user interface 100A are indicated by an icon 103. The icon may be color coded or have a shape (for example, a circle 103A or a triangle 103B) based on the performance of the student during the training session. For example, a score 105 above a predetermined value (such as 82) may be indicated by a first icon 103A of a first color, such as green. The first icon 103A may have a first shape, such as circular. A score below a predetermined value (such as 65) can be represented by a third icon with a third color. The third color may be red. A score between the upper and lower values (for example, between 65 and 82) may be shown with a second icon 103B. The second icon 103B may have a second color. In one embodiment, the second color is amber or yellow.

Additionally, or alternatively, the scores 105 may include a numerical value. For example, the score 105A is illustrated as “76.3” in FIG. 5.

In one embodiment, the score 105A of the training session is related to the scores 105B, 105C, 105D of two or more tasks 82 performed during the training session. Optionally, the score 105A displayed in the summary field 104 is an average of two or more scores 105 of tasks displayed in a training tasks field 106. The report module 72 can obtain data for the scores from the evaluation module 64.

The training tasks field 106 field displays information about a task or tasks 82 performed by the student 2 during the training session. For example, the exemplary training tasks field 106 of FIG. 5 displays information about four tasks including a “Lazy 8” 82A, a “Power-On Stall” 82B, a “Vertical S” 82C, and an “Overhead Pattern” 82D. A score 105 may be associated with one or more of the tasks. A start time for each task can also be displayed in the training tasks field.

In one embodiment, a user (such as a student 2 or an instructor 4) can select a task 82 shown in the training tasks field 106. In response, the report module 72 can display more information about the selected task in the details field 108. The details field 108 optionally includes a name of the selected task, a time the task was initiated as well as a duration of the task, and a score 105C for the task. In one embodiment, the score for the task is an average of all variables or features 90 scored within the task 82. Optionally, the score can visually change based on whether the score for the task is passing, marginal, or failing. In one embodiment, a passing score is presented in green text or by a green icon (such as circle icon 103A), a marginal score is presented in amber text (such as a triangular icon 103B as generally illustrated in FIG. 5), and a failing score is presented in red text (or by a red icon).

One or more fields 114 displaying data recorded by the training device 6 as the student 2 performed that task may also be presented. The fields 114 may correspond to one or more features 90 associated with each task.

For example, a first field 114A for a first feature 90A is presented. In this example, the first feature is labeled “Altitude (MSL)” and is related to altitude during performance of the task 82B by the student operator 2. The first field may provide data about a goal for the first feature 90A of the task 82 (such as “minimal loss of altitude during recover”), a target value, the student's value, and a difference or “delta” between the target and student value. The target value for the goal of the first feature 90A is 350 feet.

The first field 114A may include a score for the first feature determined by the evaluation module 64. Optionally, the score of the student 2 for the feature 90A may be indicated by a score bar 116. In one embodiment, the score bar is configured to visually change based on the feature score. For example, the score bar may be color coded such that the score bar 116A is green for a passing score, amber for a marginal score, and the score bar 116C is red for a failing score.

The first field 114A can also present a graph of the student's performance 110 over time compared to a baseline value 112 for the task feature. The graph may display trend, frequency, and amplitude of the student's performance 110. In this manner, the “smoothness” of the student's execution of the task can be identified and/or measured.

The baseline value 112 may be determined by the task module 62. In the example of FIG. 5, the first field 114A provides data about altitude as the student executed a “Power-On Stall”.

A second feature 90B associated with the task 82 can be presented in a second field 114B. Notably, the second field 114B can include two or more goals. For example, for the task “Power-On Stall” 82B, the second feature 90B is related to “bank angle” of the aircraft and includes a first goal and a second goal. In this example, the first goal is related to maintaining bank angle during entry. The second goal is for maintaining bank angle during recovery.

Each goal includes a target value, the student's value, and a delta between the target and student value. The target value may be different for each goal. For example, the target for the first goal of the second feature 90B is −3.6°. In contrast, the target for the second goal is −17.7°.

A graph in the second field illustrates the student's performance 110 compared to the baseline value 112. In one embodiment, portions 110A of the student data that meet the goals can have a first pattern (for example, by a solid line) or a first color, such as blue. However, portions 110B of the student data that exceed the goals can be illustrated in a graph in a different second pattern (such as by a dashed line) or second color, such as red.

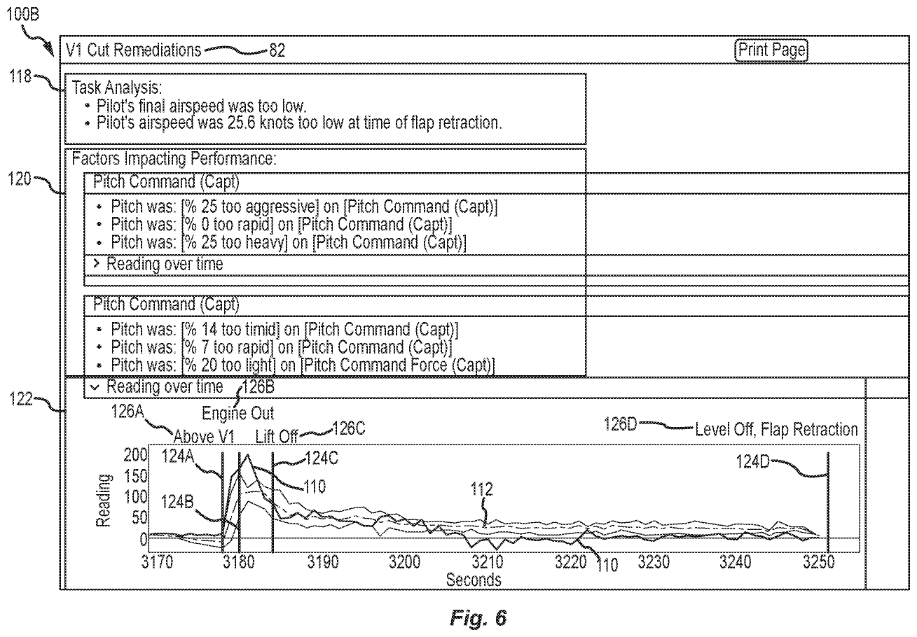

Referring now to FIG. 6, another user interface 100B generated by the training system 20 and the report module 72 is generally illustrated. The user interface 100B provides additional data about an evaluation of a task 82 executed by a student 2 using the training device 6. More specifically, user interface 100B provides insights into what the student 2 did wrong during a training session and how the student can improve. In this embodiment, the training device 6 is configured to emulate an aircraft and the task 82 is entitled “V1 Cut Remediations”.

The user interface 100B created by the report module 72 may include data from the evaluation module 64. More specifically, the user interface 100B may include a task analysis field 118 that includes a reason for a deviation from a standard or baseline 112 for a task 82 performed by the student 2. The task analysis field 118 can provide information about handling or performance of the simulated vehicle that did not conform with the requirements of the task. In the exemplary user interface 100B of FIG. 6, the task analysis field 118 indicates that the student 2 failed to maintain adequate aircraft velocity, “Pilot's final airspeed was too low”, at a specific time during execution of the task.

The user interface 100B may also include a factors field 120. The report module 72 can retrieve data from one or more of the evaluation module 64 and the recommendation module 68 for the factors field. In one embodiment, the factors field 120 includes a description of a reason the task 82 performed by the student 2 deviated from the standard. The factors field 120 can include any number of reasons the student 2 deviated from the standard as determined by the recommendation module 68. In one embodiment, the report module 72 can include up to three reasons identified by the recommendation module 68 in the factors field 120.

The factors field 120 may include a critique of an input to a control 12 of the training device 6 by the student. For example, the factors field may describe the control input as being too aggressive, too rapid, too heavy, too timid, too slow, too light and the like compared to the baseline model determined by the task module 62.

The factors field 120 can also critique an amount of force applied to a control 12 by the student 2 during performance of the task 82. In one embodiment, the force critique may comprise one or more of too light, too heavy, too aggressive, too timid, too rapid, and too slow. Other ratings are contemplated.

A graph 122 may also be presented in the user interface 100B. The student's performance 110 of the task is compared to the baseline value 112 in the graph. The graph 122 can also include event points 124. The event points 124 may include an event label 126 to describe the relevance of the event. For example, for a training session in an aircraft simulator 6A during which the student performed a task 82 entitled, “V1 Cut Remediations”, a first event label 126A indicates “Above V1” at event point 124A, a second event label 126B indicates “Engine out” at the second event point 124B. A third event point 124C is associated with a third event label 126C captioned “Lift Off”. A fourth event label 126D is labeled “Level Off, Flap Retraction” at a fourth event point 124D. As will be appreciated by one of skill in the art, the event labels 126 will change for different tasks and will be different for other types of vehicles and other aircraft.

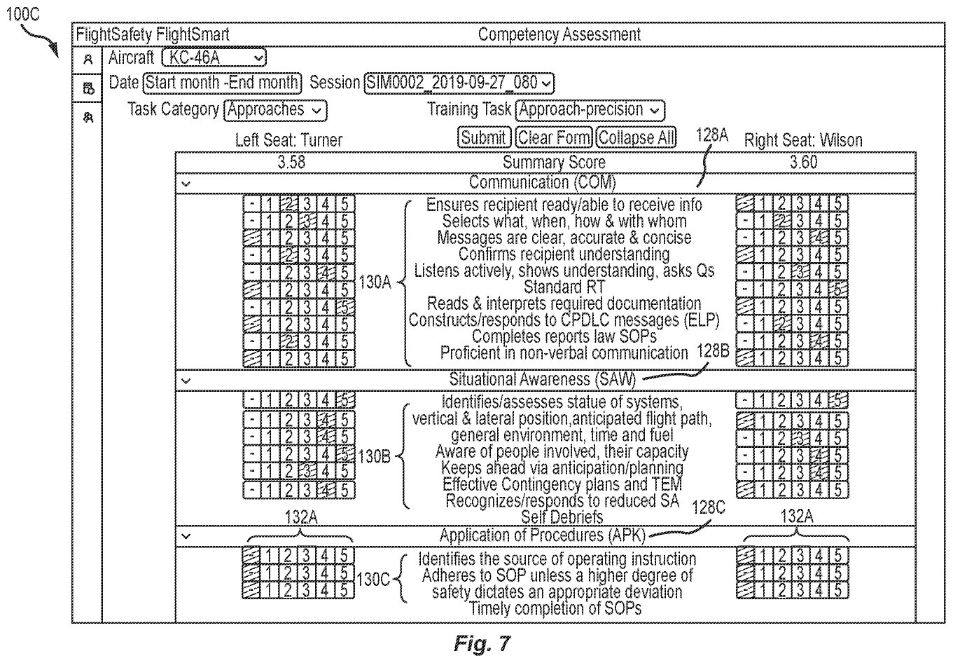

Referring now to FIG. 7, an example of a third user interface 100C generated by the report module 72 is generally illustrated. The user interface 100C provides selected fields for an instructor 4 to evaluate a student 2 after a training session. The user interface includes fields to describe a type of vehicle, a date of the training session, an identifier for the training session, a category for a task 82 performed during the training session, and a description of the task.

Criteria 128 for the task are presented in the user interface 100C. The report module 72 can retrieve data from the evaluation module 64 and the task module 62 to populate the criteria 128 portions of the user interface. The criteria may be related to communication of the student (criteria 128A), situational awareness of the student (criteria 128B), application of procedures (criteria 128C), and others. Other criteria 128 may optionally include: leadership and teamwork, workload management, problem solving and decision making, flight path management, and knowledge.

One or more factors 130 are provided for each criteria 128. A grade scale 132 with selectable buttons is associated with each of the factors 130. A user, such as an instructor 4, can select buttons in the grade scale 132 to assign a grade to a student 2 for each factor. The user interface 100C can include two or more grade scales 132 for training devices 6 with more than one student 2.

In one embodiment, the evaluation module 64 assigns the grades for a student for each factor in the user interface 100C. The report module 72 then retrieves the scores and then generates user interface 100C. In this manner, the training system 20 supports automatic grading of a student 2. Additionally, or alternatively, an instructor 4 may enter or alter a score for a student.

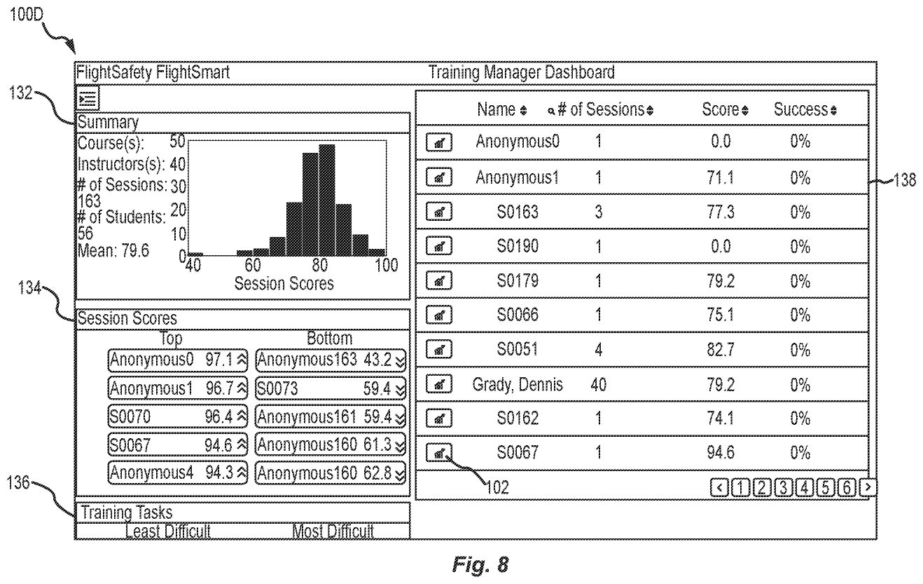

Another embodiment of a user interface 100D generated by the report module 72 is generally illustrated in FIG. 8. The user interface 100D provides insights for program managers and/or instructors 4 for how entire cohorts of students 2 performed during training sessions. Filtering is available by vehicle type and by instructor.

A manager may review grading of students 2 by a selected instructor 4 and progression of students assigned to the instructor. In this manner, the manager can evaluate the performance of the selected instructor. This filtering also facilitates instructor standardization. For example, by reviewing student performance for two different instructors, a manager can determine whether the instructors are uniformly grading students.

In one embodiment, the user interface 100D provides a summary field 132. The summary field 132 provides a histogram of scores of students 2 in a selected population.

A session score field 134 provides information on students 2 ranked highest in a course and students 2 ranked lowest in the course. In one embodiment, the session score field displays the top five students 2 and the bottom five students. Optionally, names of the students 2 may be displayed in the session score field 134. However, in some embodiments, the names of the students are not displayed or are replaced with an anonymous identifier to protect the privacy of the students.

User interface 100D may also include a training task field 136. Field 136 may list tasks 82 that the students in the selected population find least difficult and/or most difficult. The “least difficult tasks” refer to those tasks with the highest average score for students in the selected population. Similarly, the “most difficult tasks” are those tasks with the lowest average score for the student. In one embodiment, up to five or more least difficult tasks and/or most difficult tasks may be displayed in user interface 100D.

Additionally, or alternatively, the user interface 100D can include a student list field 138 with information about each student 2 in the selected population. The student list field may include a name of each student (or a unique identification for one or more students) and one or more of a number of training sessions completed by each student, a score for each student, a success rate for each student, and the like.

Optionally, a selectable button 102 is associated with each student 2 listed in the student list field 138. A user can select the button for a student to display that student's progress view. The progress view may present data about the selected student's performance, such as their best and worst training tasks, and their progress over time.

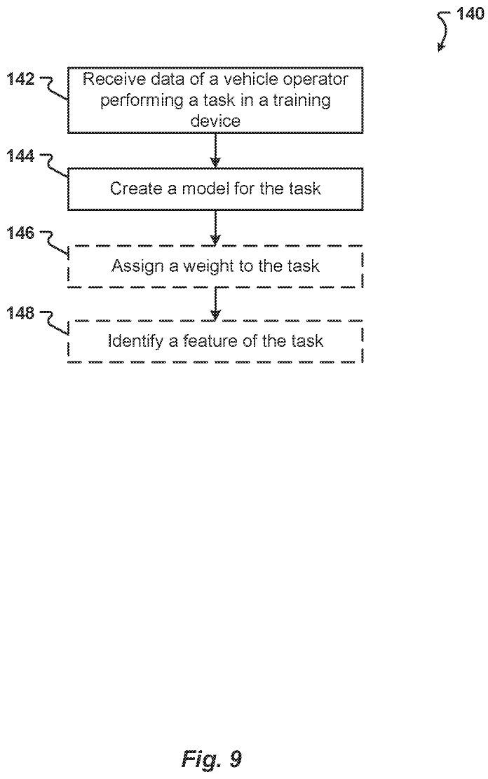

Referring now to FIG. 9, one embodiment of a method creating a model of a task 82 of the present disclosure is generally illustrated. While a general order of the operations of method 140 are shown in FIG. 9, method 140 can include more or fewer operations, or can arrange the order of the operations differently than those shown in FIG. 9. Further, although the operations of method 140 may be described sequentially, many of the operations may in fact be performed in parallel or concurrently. Portions of method 140 can be executed as a set of computer-executable instructions executed by a computer system and encoded or stored on a computer readable medium. One example of the computer system may include the training system 20. An example of the computer readable medium may include, but is not limited to, a memory 30, 36 of the training system 20. Hereinafter, method 140 shall be explained with reference to the components described in conjunction with FIGS. 1-8.

In operation 142, the training system 20 receives task data of at least one operator 2 executing a task 82 with a training device 6. In one embodiment, the task data is stored in one or more databases 40, 42, or 48 accessible by the training system. The task data may be associated with one or with a plurality of operators 2 that have performed the task using a training device 6. The task data includes inputs to the controls 12 of the training device as well as data from a sensor 14 of the training device.

In operation 144, a model of the task 82 is created by the training system. The task module 62 can retrieve and analyze the task data to create the model. In one embodiment, the task module uses machine learning to build the model. Optionally, the task module may organize the task data into a cluster or clusters. The task data may also be categorized by the task module. In one embodiment, the task module 62 performs regression analysis on one or more clusters of task data.

In operation 146, the task module 62 can optionally assign a weight to the task. The weight is a measure of importance of the task.

Optionally, in operation 148, the task module 62 may identify features 90 of the task 82. For example, the task module 62 may identify criteria that indicate initiation of the task and ending of the task. The task module can also identify events or features that occur between initiation and ending of the task. The task module can also identify grading criteria for each feature of a task. The task module may store the task model and other data related to the task in a data structure 80. The features may be assigned a weight or importance by the task module.

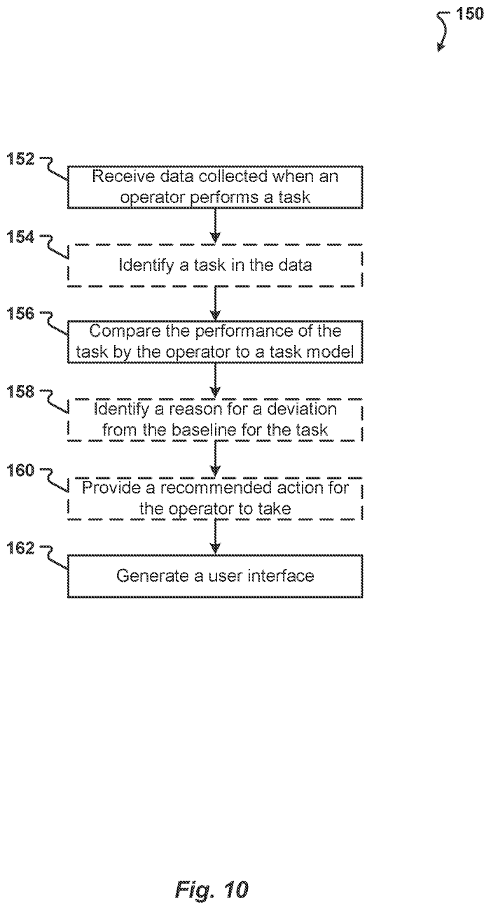

Referring now to FIG. 10, a method of evaluating the performance of a task by a vehicle operator 2 during a training session is generally illustrated. While a general order of the operations of method 150 are shown in FIG. 10, method 150 can include more or fewer operations, or can arrange the order of the operations differently than those shown in FIG. 10. Further, although the operations of method 150 may be described sequentially, many of the operations may in fact be performed in parallel or concurrently. Portions of method 150 can be executed as a set of computer-executable instructions executed by a computer system and encoded or stored on a computer readable medium. One example of the computer system may include the training system 20. An example of the computer readable medium may include, but is not limited to, a memory of the training system 20. Hereinafter, method 150 shall be explained with reference to the components described in conjunction with FIGS. 1-9.

In operation 152, the training system 20 receives data collected by sensors 14 when an operator 2 performs a task 82 during a training session with a training device 6. The operator may be a student 2 learning to operate a vehicle, such as an aircraft. The data can include information collected by a sensor 14 of the training device as well as data related to inputs the operator makes to controls 12 to execute the task 82. In one embodiment, the training system 20 retrieves the data from the operator database 44. The training system may also retrieve data using a network connection 46 to another data source, such as an external database 48 or a remote computer 49.

Optionally, in operation 154, one or more tasks performed by the operator 2 during the training session are identified by the evaluation module 64 in the data. In one embodiment, operation 154 includes retrieving task data from the task data file 80. The evaluation module 64 can compare the data to the start criteria 86 and/or the end criteria 88 of tasks 82A . . . 82N in the task data file to identify a start time and a finish time of each task in the data.

In operation 156, the evaluation module 64 compares a portion of the data related to execution of the task 82 to a model of the task. In one embodiment, operation 156 includes evaluation of features 90 of the task 82 performed by the operator 2.

To evaluate performance of the task by the operator, the evaluation module 64 may compare the data to a baseline for the task. The evaluation module can compare handling of the simulated vehicle by the operator to the baseline. The similarity of the data to the baseline is then measured by the evaluation module.

In one embodiment, the evaluation module 64 may provide a passing grade if the operator meets a standard required for a task. Additionally, or alternatively, the evaluation module may assign a score to indicate smoothness of the operator's performance of the task. The smoothness score in based at least in part to the trend, frequency, and amplitude of movement of the simulated vehicle in response to inputs to controls 12 made by the operator 2. In another embodiment, the evaluation module can assign the score based on a difference between the execution of a task by the operator 2 and a baseline for the task. In still another embodiment, the evaluation module will determine a score for the task using two or more of the grading methods described herein.

Optionally, operation 156 includes assigning a score to features 90 of the task 82. More specifically, each task may include one, two or more features that can be individually graded by the evaluation module 64. In one embodiment, the score for a task 82 is the average of scores for each feature 90 of the task.

In optional operation 158, the training system 20 can provide a reason for a deviation by the operator from the baseline for the task. For example, the training system 20 may determine that the operator failed to take an action required by a task. Additionally, or alternatively, the training system 20 may determine the operator failed to consider information required to successfully complete the task. In one embodiment, the training system may determine that the operator did not successfully complete the task due to inadvertent action by the operator (such as an improper input) or because of an input by a second operator.

Method 150 may optionally include operation 160 in which the training system provides a recommended action for the operator to take. The recommendation action may be a feature of a task the operator should practice to become proficient in the task and/or to improve performance of the task.

In operation 162, the training system 20 generates a user interface 100 for a user. In one embodiment, the user interface 100 includes a score for the task. Optionally, the user interface further includes a score for at least one feature associated with the task. In one embodiment, the user interface has a graph illustrating execution of the task by the operator compared to a baseline from a model of the task.

The systems and methods of the present disclosure provide many benefits. For example, the training system 20 of the present disclosure delivers an objective and intelligent assessment of operator performance throughout a training course. The training system reduces the time required for an operator to successfully complete a task 82 and increases throughput of students 2 through courses which utilize a training device 6. The training system facilitates personalized training paths for students as opposed to a rigid, one-size fits-all syllabus.

In addition, the training system of the present disclosure can evaluate all sensor data and control inputs of students 2 collected by sensors 14 during a training session. In this manner, the training system considers and analyzes information that cannot be observed or evaluated by a human instructor 4. Accordingly, the training system provides insights into elements of student performance that are not otherwise available to the instructor.

The training system provides recommended actions for students to take to improve performance. The training system may also recommend changes in a course based on performance of a student or identification of a student persona. In this way, the training system of the present disclosure reduces student attrition and additional training requirements through early recognition of causes of substandard student performance and intervention to improve student performance.

Another benefit is that the training system supports adaptive learning, competency-based training and assessment (CBTA), and evidence based training (EBT). Moreover, systems and methods of the present disclosure identify gaps and trends in individual student or population performance leading to improvements in training curriculum. Further, the training system facilitates remediation and training plan adaptation based on student performance.

The training system can also provide tangible, student-specific feedback and corrections. More specifically, the instructor 4 is provided objective information about execution of a task by the student which can be used to fully debrief the student 2 and provide suggestions for corrective actions the student can take to improve performance. This allows immediate reinforcement of training lessons and gives students (including student pilots) and instructors a chance to identify areas for special emphasis. The training system can identify small, but important, irregularities that may have been missed by an instructor during a session in a training device.

In some embodiments, the training system 20 will provide a score for a task performed by a student 2 during a training session. In this manner, the instructor 4 can provide analysis of the performance of the student 2 and feedback to the student during the training session. This reduces the time between performance of an action and receipt of feedback.

Further, workload on the instructor 4 is reduced by the training system of the present disclosure. The instructor does not have to take notes or try to remember all actions taken by the student 2 during a training session with a training device 6. Instead, the instructor can focus on the performance of the student and provide an objective feedback to the student.

The training system 20 also promotes training standardization through objective evaluation of student performance. In this manner, biases (either intentional or inadvertent) in training that are introduced by an instructor are eliminated. The training system 20 can identify differences in the trends of training provided at different locations or between different instructors.

The training system can be used to identify problems and address them early in the training process. In this manner, the training system improves efficiency by eliminating the need for additional or remedial training. Another use is to help an instructor adapt the training style to the characteristics of a student. For example, a student with little experience in the vehicle may benefit from practicing tasks that would not be beneficial to a student who was previously qualified in the vehicle but has not operated the vehicle for a substantial amount of time.

A further use is to help an instructor or course director screen students to identify students unlikely to successfully complete a training syllabus for the vehicle on time. Early identification and elimination of students who may not be able to complete the training saves time and money. Similarly, quick identification of students who can advance through training more quickly than other students also saves time.

While various embodiments of the system have been described in detail, it is apparent that modifications and alterations of those embodiments will occur to those skilled in the art. It is to be expressly understood that such modifications and alterations are within the scope and spirit of the present disclosure. Further, it is to be understood that the phraseology and terminology used herein is for the purposes of description and should not be regarded as limiting. The use of “including,” “comprising,” or “having” and variations thereof herein are meant to encompass the items listed thereafter and equivalents thereof, as well as, additional items.

Although the exemplary aspects, embodiments, options, and/or configurations illustrated herein may show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a Personal Computer (PC), laptop, netbook, smart phone, Personal Digital Assistant (PDA), tablet, etc., or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects. A number of variations and modifications of the disclosure can be used. It would be possible to provide for some features of the disclosure without providing others.

It should be appreciated that the various processing modules (e.g., processors, modules, etc.), for example, can perform, monitor, and/or control critical and non-critical tasks, functions, and operations, such as interaction with and/or monitoring and/or control of sensors and device operation.

Optionally, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

To provide additional background, context, and to further satisfy the written description requirements of 35 U.S.C. § 112, the following references are incorporated by reference herein in their entireties: U.S. Pat. Nos. 10,311,742; 10,679,513; U.S. Pat. 10,68,5582; U.S. Pat. Pub. 2008/0206720; U.S. Pat. Pub. 2017/0236439; U.S. Pat. Pub. 2017/0286838; U.S. Pat. Pub. 2017/0287349; U.S. Pat. Pub. 2017/0287350; U.S. Pat. Pub. 2018/0232045; U.S. Pat. Pub. 2018/0284751; U.S. Pat. Pub. 2019/0304324; U.S. Pat. Pub. 2019/0304325; U.S. Pat. Pub. 2020/0050720; and U.S. Pat. Pub. 2020/0066178.

What is claimed is:

1. A flight simulator for training a student to operate an aircraft and to evaluate performance of the student during a training session in the flight simulator, comprising:
a display system;
an input apparatus to receive an input from the student during execution of a first task during the training session;
a sensor to record data during the training session; and
a control system including a processor, a non-transitory computer-readable storage medium, and instructions stored on the non-transitory computer-readable storage medium for execution by the processor, including:
an instruction to receive data from the sensor;
an instruction to compare performance of the first task by the student to a model of the first task;
an instruction to assign a first score to the performance of the first task by the student;
an instruction to identify a reason for a deviation from a baseline for the first task performed by the student;
an instruction to determine a recommended action for the student to improve performance of the first task; and
an instruction to select a second task for the student to execute during the training session.

2. The flight simulator of claim 1, wherein the control system automatically initiates the second task during the training session and the instructions further comprise:
an instruction to send a signal to the display system to provide a virtual view associated with the second task;
an instruction to compare performance of the second task by the student to a model of the second task;
an instruction to assign a second score to the performance of the second task by the student.

3. The flight simulator of claim 1, wherein the instruction to select the second task includes an instruction to retrieve a persona associated with the student from a database, wherein the persona indicates a vehicle operating style associated with the student.

4. The flight simulator of claim 1, wherein the instruction to select the second task includes an instruction to review sensor data collected as the student performed tasks during previous training sessions in the flight simulator.

5. The flight simulator of claim 1, further comprising an instruction to determine a probability that the student will successfully complete a training course associated with the first task.

6. The flight simulator of claim 1, further comprising an instruction to generate a user interface that includes the first score and the recommended action.

7. The flight simulator of claim 1, wherein the input apparatus includes a throttle and a steering element.

8. The flight simulator of claim 1, further comprising a motion element to move a portion of the flight simulator to replicate motion of the aircraft.

9. A computer-implemented method of evaluating performance of a task in a vehicle simulator by a vehicle operator, comprising:
receiving data collected by a sensor when the vehicle operator performs the task;
comparing performance of the task by the vehicle operator to a model of the task;
assigning a score to the performance of the task by the vehicle operator;
identifying a reason for a deviation from a baseline for the task;
providing a recommended action for the vehicle operator to improve performance of the task; and
generating a user interface that includes the score.

10. The method of claim 9, further comprising generating the model of the task by:
receiving data of vehicle operators performing the task in the vehicle simulator; and
creating the model of the task using the received data.

11. The method of claim 10, wherein creating the model includes using a machine learning method.

12. The method of claim 11, wherein the machine learning method is one or more of a supervised machine learning method, an unsupervised machine learning method, and a semi-supervised machine learning method.

13. The method of claim 10, further comprising identifying criteria to determine initiation of the task and completion of the task.

14. The method of claim 13, wherein the data comprises a plurality of tasks performed by the vehicle operator and the method further comprises:
determining a start time and an end time of the task using the initiation criteria and the completion criteria.

15. The method of claim 9, further comprising determining a probability that the vehicle operator will successfully complete a training course associated with the task.

16. The method of claim 9, where the vehicle simulator is an aircraft flight simulator and the task is a flight maneuver.

17. A system for evaluating performance of a task in a vehicle simulator by a student and providing feedback to the student, comprising:
a processor;
a non-transitory computer-readable storage medium; and
instructions stored on the non-transitory computer-readable storage medium for execution by the processor, including:
an instruction to receive data collected by a sensor when the student performs the task;
an instruction to compare performance of the task by the student to a model of the task;
an instruction to assign a score to the performance of the task by the student;
an instruction to identify a reason for a deviation from a baseline for the task;
an instruction to provide a recommended action for the student to improve performance of the task; and
an instruction to generate a user interface that includes the score.

18. The system of claim 17, further comprising:
an instruction to receive data collected by the sensor of an operator proficient in the vehicle performing the task in the vehicle simulator; and
an instruction to create the model of the task using the received data, wherein creating the model includes using one or more of a supervised machine learning method, an unsupervised machine learning method, and a semi-supervised machine learning method.

19. The system of claim 17, wherein the system is connected to the vehicle simulator.

20. The system of claim 19, wherein the vehicle simulator is a flight simulator and the task is a flight maneuver.
